(19) United States
(12) Patent Application Publication
(10) Pub. No.: US 2026/0281745 A1
(43) Pub. Date: Sep. 17, 2026

(54) COMMUNICATION METHODS, APPARATUSES, DEVICE, AND STORAGE MEDIUM

(71) Applicant: BEIJING XIAOMI MOBILE SOFTWARE CO., LTD., Beijing (CN)

(72) Inventor: Yi XIONG, Beijing (CN)

(21) Appl. No.: 19/469,349

(22) PCT Filed: Mar. 31, 2023
(86) PCT No.: PCT/CN2023/085797

§ 371 Date: Sep. 25, 2025

(51) Int. Cl. H04W 24/02; H04W 24/10; H04W 64/00

(52) U.S. Cl. CPC H04W 24/02; H04W 24/10; H04W 64/00

(57) ABSTRACT

A communication method for use in a mobile communications network includes: sending first information, the first information indicating at least one of a configuration applied by the terminal and a change occurring in the configuration applied to the terminal having changed.

### CROSS-REFERENCE TO RELATED APPLICATION

This application is a U.S. national phase of International Application No. PCT/CN2023/085797, filed with the State Intellectual Property Office of P.R. China on Mar. 31, 2023.

### TECHNICAL FIELD

The present disclosure relates to a field of mobile communication networks, and specifically to a communication method and apparatus, a device, and a storage medium.

### BACKGROUND

In a mobile communication system, a plurality of operating configurations are provided within a terminal. When an environment in which the terminal is located changes, the terminal will select different configurations from the plurality of operating configurations to perform beam measurement and information transmission.

### SUMMARY

According to a first aspect of the present disclosure, a communication method is provided. The method is performed by a terminal and includes:

sending first information, in which the first information indicates at least one of: a configuration applied by the terminal or a change occurring in the configuration applied by the terminal.

According to a second aspect of the present disclosure, a communication method is provided. The method is performed by a network device and includes:
receiving first information, in which the first information indicates at least one of: a configuration applied by the terminal or a change occurring in the configuration applied by the terminal.

According to a third aspect of the present disclosure, a communication device is provided, including:
one or more processors,
in which the one or more processors are configured to invoke instructions to cause the communication device to implement the communication method according to the above aspects.

### BRIEF DESCRIPTION OF THE DRAWINGS

In order to more clearly illustrate embodiments of the present disclosure or technical solutions in the related art, embodiments or accompanying drawings needed to use in the related technical description will be introduced clearly below. Apparently, the accompanying drawings described below are only a part of embodiments of the present disclosure. For the ordinary skilled in the art, other drawings may further be obtained based on these accompanying drawings without creative work.

FIG. 1a is a schematic diagram of a communication system according to an embodiment of the present disclosure.

FIG. 1b is a schematic diagram of a communication system according to an embodiment of the present disclosure.

FIG. 2 is an interactive schematic diagram of a communication method according to an embodiment of the present disclosure.

FIG. 3a is a flowchart of a communication method performed by a terminal according to an embodiment of the present disclosure.

FIG. 3b is a flowchart of a communication method according to an embodiment of the present disclosure.

FIG. 3c is a flowchart of a communication method according to an embodiment of the present disclosure.

FIG. 3d is a flowchart of a communication method according to an embodiment of the present disclosure.

FIG. 3e is a flowchart of a communication method according to an embodiment of the present disclosure.

FIG. 3f is a flowchart of a communication method according to an embodiment of the present disclosure.

FIG. 3g is a flowchart of a communication method according to an embodiment of the present disclosure.

FIG. 3h is a flowchart of a communication method according to an embodiment of the present disclosure.

FIG. 3i is a flowchart of a communication method according to an embodiment of the present disclosure.

FIG. 3j is a flowchart of a communication method according to an embodiment of the present disclosure.

FIG. 3k is a flowchart of a communication method according to an embodiment of the present disclosure.

FIG. 4a is a flowchart of a communication method performed by a network device according to an embodiment of the present disclosure.

FIG. 4b is a flowchart of a communication method according to an embodiment of the present disclosure.

FIG. 4c is a flowchart of a communication method according to an embodiment of the present disclosure.

FIG. 4d is a flowchart of a measurement reporting method according to an embodiment of the present disclosure.

FIG. 5 is a flowchart of a communication method according to an embodiment of the present disclosure.

FIG. 6 is a schematic diagram of a communication method according to an embodiment of the present disclosure.

FIG. 7a is a block diagram of a first communication apparatus according to an embodiment of the present disclosure.

FIG. 7b is a block diagram of a second communication apparatus according to an embodiment of the present disclosure.

FIG. 8a is a block diagram of a communication device according to an embodiment of the present disclosure.

FIG. 8b is a block diagram of a chip according to an embodiment of the present disclosure.

### DETAILED DESCRIPTION

To extend content of information reported by a terminal, embodiments of the present disclosure provide a communication method and apparatus, a device, and a storage medium.

According to a first aspect, the embodiments of the present disclosure provide a communication method. The method is performed by a terminal and includes:
sending first information, in which the first information indicates at least one of: a configuration applied by the terminal or a change of the configuration applied by the terminal.

In the above embodiment, the terminal may report information indicating at least one of: the applied configuration or whether the configuration changes, which ensures that the network device may learn the configuration currently applied by the terminal and guarantees communication reliability.

In combination with some embodiments of the first aspect, in some embodiments, sending the first information includes at least one of:
sending the first information in a case that the configuration applied by the terminal changes; or
sending the first information in a case that the terminal has not sent the first information.

In the above embodiment, the terminal may trigger to send the first message under different circumstances, which facilitates reporting the configuration applied by the terminal to the network device and improves accuracy that the terminal reports the first information.

In combination with some embodiments of the first aspect, in some embodiments, sending the first information in a case that the terminal has not sent the first information includes:
sending the first information in a case that the terminal has not sent the first information since the terminal is configured to send the first information via a first message.

In the above embodiment, after the terminal is configured to send the first information via the first message, the terminal determines whether the first information has been sent in order to send the first information, which facilitates reporting the configuration applied by the terminal to the network device and improves accuracy that the terminal reports the first information.

In combination with some embodiments of the first aspect, in some embodiments, the method further includes:
receiving second information, in which the second information is used to configure whether the terminal indicates, via the first information, at least one of: the configuration applied by the terminal or the change occurring in the configuration applied by the terminal.

In the above embodiment, the network device configures, based on the second information for the terminal, that the configuration applied by itself needs to be reported, which ensures that the terminal may report the applied configuration according to the configuration and guarantees communication reliability.

In combination with some embodiments of the first aspect, in some embodiments, the first information is included in a first message.

In combination with some embodiments of the first aspect, in some embodiments, the first message is a measurement report or the first message is user equipment (UE) assistance information (UAI).

In the above embodiment, the terminal sends the first information to the network device via the measurement report or the UAI, which saves signaling overhead.

In combination with some embodiments of the first aspect, in some embodiments, the method further includes at least one of:
determining whether the configuration applied by the terminal changes, and determining whether a first message that is sent includes the first information; or
determining whether the configuration applied by the terminal changes, and determining a value of the first information included in a first message that is sent.

In the above embodiment, the terminal may determine the first information based on whether the configuration applied by the terminal changes, which improves accuracy of determining the first information.

In combination with some embodiments of the first aspect, in some embodiments, determining whether the configuration applied by the terminal changes, and determining whether the first message that is sent includes the first information includes:
determining that the configuration applied by the terminal changes and the first message includes the first information;
or,
determining that the configuration applied by the terminal does not change and the first message includes the first information.

In the above embodiment, the terminal indicates whether the configuration applied by the terminal changes via different forms of the first information in the first message, which expands forms of the indication of the terminal, and improves accuracy that the terminal indicates whether the configuration applied by the terminal changes.

In combination with some embodiments of the first aspect, in some embodiments, determining whether the configuration applied by the terminal changes, and determining the value of the first information included in the first message that is sent includes at least one of:
determining that the configuration applied by the terminal changes and the first information is a first value; or
determining that the configuration applied by the terminal does not change and the first information is a second value.

In the above embodiment, the terminal indicates whether the configuration applied by the terminal changes via different values of the first information in the first message, which expands forms of the indication of the terminal, and improves accuracy that the terminal indicates whether the configuration applied by the terminal changes.

In combination with some embodiments of the first aspect, in some embodiments, the first information includes at least one of:
the first information being set to a parameter name corresponding to a configuration currently applied by the terminal;
the first information being set to a parameter value corresponding to a configuration currently applied by the terminal; or
the first information being set to a configuration identifier corresponding to a configuration currently applied by the terminal.

In the above embodiment, the terminal indicates the configuration applied by the terminal by setting the first information in different forms, which expands forms of the indication of the terminal, and improves accuracy that the terminal indicates the configuration that is applied.

In combination with some embodiments of the first aspect, in some embodiments, the configuration applied by the terminal is a configuration corresponding to a neighboring cell or a non-serving cell.

In combination with some embodiments of the first aspect, in some embodiments, the first information further indicates a corresponding relationship between the configuration corresponding to the neighboring cell or the non-serving cell and a cell identifier of the neighboring cell or the non-serving cell;
or,
the first information further indicates at least one of: a corresponding relationship between a default configuration and a cell identifier of the neighboring cell or the non-serving cell, or a corresponding relationship between a non-default configuration and the neighboring cell or the non-serving cell.

In the above embodiment, the terminal also reports the corresponding relationship between the neighboring cell and the configuration, so that the network device may determine the configuration corresponding to each neighboring cell, which improves accuracy of the configuration that is reported, and ensures communication reliability.

In combination with some embodiments of the first aspect, in some embodiments, determining whether the configuration applied by the terminal changes includes at least one of:
determining whether the configuration applied by the terminal changes based on whether a height of the terminal changes; or
determining whether the configuration applied by the terminal changes from a first configuration to a second configuration.

In combination with some embodiments of the first aspect, in some embodiments, the height includes at least one of:
the height of the terminal being above a first threshold;
the height of the terminal not being above the first threshold;
the height of the terminal being below the first threshold;
the height of the terminal not being below the first threshold;
the height of the terminal falling within a first range; or
the height of the terminal not falling within the first range.

In the above embodiment, the terminal may determine that the applied configuration changes under different circumstances, which expands diversity that the terminal determines the change occurring in the applied configuration, and further improves accuracy that the terminal determines that the applied configuration changes.

In combination with some embodiments of the first aspect, in some embodiments, the configuration applied by the terminal is a measurement configuration.

In combination with some embodiments of the first aspect, in some embodiments, the second information indicates at least one of:
sending the first message in a case that the configuration applied by the terminal changes;
carrying the first information in the first message that is sent by the terminal every time; or
carrying the first information in the first message that is sent most recently after the configuration applied by the terminal changes.

In the above embodiments, the network device may configure different reporting methods for the terminal, and thus the terminal may report the configuration applied by the terminal based on the different reporting methods, which expands diversity of the configuration of the network device.

In combination with some embodiments of the first aspect, in some embodiments, the second information indicates at least one of:
sending the first message in a case that the configuration applied by the terminal changes;
sending the first message in a case that the terminal has not sent the first information since the terminal is configured to send the first information via a second message;
sending the first message in a case that the configuration currently applied by the terminal is not a default configuration and the terminal has not sent the first information since the terminal is configured to send the first information via a second message; or
sending the first message in a case that the configuration currently applied by the terminal is different from the configuration applied by the terminal that is sent last time.

In the above embodiments, the network device instructs the terminal to send the second message using second indication information with different functions, which expands diversity of the second indication information and thus ensures accuracy of the configuration.

In combination with some embodiments of the first aspect, in some embodiments, the method further includes at least one of:
determining whether the configuration applied by the terminal changes based on whether the first information includes first indication information; or
determining whether the configuration applied by the terminal changes based on first indication information included in the first information.

In combination with some embodiments of the first aspect, in some embodiments, determining whether the configuration applied by the terminal changes based on whether the first information includes the first indication information includes at least one of:
the first information indicating that the configuration applied by the terminal changes based on the first information including the first indication information; the first information indicating that the configuration applied by the terminal does not change based on the first information not including the first indication information;
or,
the first information indicating that the configuration applied by the terminal does not change based on the first information including the first indication information; the first information indicating that the configuration applied by the terminal changes based on the first information not including the first indication information.

In combination with some embodiments of the first aspect, in some embodiments, determining whether the configuration applied by the terminal changes based on the first indication information included in the first information includes at least one of:
the first information indicating that the configuration applied by the terminal changes based on the first indication information being a first value; or
the first information indicating that the configuration applied by the terminal does not change based on the first indication information being a second value.

In combination with some embodiments of the first aspect, in some embodiments, the first information includes second indication information, and the second indication information indicates the configuration currently applied by the terminal.

In combination with some embodiments of the first aspect, in some embodiments, the second indication information includes a parameter name corresponding to the configuration currently applied by the terminal;
or,
the second indication information includes a parameter value corresponding to the configuration currently applied by the terminal;
or,
the second indication information includes a configuration identifier corresponding to the configuration currently applied by the terminal.

According to a second aspect, the embodiments of the present disclosure provide a communication method. The method is performed by a network device and includes:
receiving first information, in which the first information indicates at least one of: a configuration applied by a terminal or a change occurring in the configuration applied by the terminal.

In the above embodiments, the terminal may report the information that indicates at least one of the applied configuration or whether the configuration changes, which ensures that the network device may be aware of the configuration currently applied by the terminal and guarantees communication reliability.

In combination with some embodiments of the second aspect, in some embodiments, the first information is sent in a case that the configuration applied by the terminal changes;
or,
the first information is sent in a case that the terminal has not sent the first information.

In combination with some embodiments of the second aspect, in some embodiments, the first information is sent in a case that the terminal has not sent the first information since the terminal is configured to send the first information via a first message.

In combination with some embodiments of the second aspect, in some embodiments, the method further includes:
sending second information, in which the second information configures whether the terminal indicates, via the first information, at least one of: the configuration applied by the terminal or the change occurring in the configuration applied by the terminal.

In combination with some embodiments of the second aspect, in some embodiments, the first information is included in a first message.

In combination with some embodiments of the second aspect, in some embodiments, the first message is a measurement report or the first message is UAI.

In combination with some embodiments of the second aspect, in some embodiments, the method further includes at least one of:
determining whether the configuration applied by the terminal changes based on whether a received first message includes the first information; or
determining whether the configuration applied by the terminal changes based on a value of the first information included in a received first message.

In combination with some embodiments of the second aspect, in some embodiments, determining whether the configuration applied by the terminal changes based on whether the received first message includes the first information includes:
determining that the configuration applied by the terminal changes based on the first message including the first information;
or,
determining that the configuration applied by the terminal does not change based on the first message including the first information.

In combination with some embodiments of the second aspect, in some embodiments, determining whether the configuration applied by the terminal changes based on the value of the first information included in the received first message includes at least one of:
determining that the configuration applied by the terminal changes based on the first information being a first value; or
determining that the configuration applied by the terminal does not change based on the first information being a second value.

In combination with some embodiments of the second aspect, in some embodiments, the first information includes at least one of:
the first information being set to a parameter name corresponding to a configuration currently applied by the terminal;
the first information being set to a parameter value corresponding to a configuration currently applied by the terminal; or
the first information being set to a configuration identifier corresponding to a configuration currently applied by the terminal.

In combination with some embodiments of the second aspect, in some embodiments, the configuration applied by the terminal is a configuration corresponding to a neighboring cell or a non-serving cell.

In combination with some embodiments of the second aspect, in some embodiments, the first information further indicates a corresponding relationship between the configuration corresponding to the neighboring cell or the non-serving cell and a cell identifier of the neighboring cell or the non-serving cell;
or,
the first information further indicates at least one of: a corresponding relationship between a default configuration and a cell identifier of the neighboring cell or the non-serving cell, or a corresponding relationship between a non-default configuration and the neighboring cell or the non-serving cell.

In combination with some embodiments of the second aspect, in some embodiments, determining whether the configuration applied by the terminal changes includes at least one of:
determining, by the terminal, whether the configuration applied by the terminal changes based on whether a height of the terminal changes; or
determining whether the configuration applied by the terminal changes from a first configuration to a second configuration.

In combination with some embodiments of the second aspect, in some embodiments, the height includes at least one of:
the height of the terminal being above a first threshold;
the height of the terminal not being above the first threshold;
the height of the terminal being below the first threshold;
the height of the terminal not being below the first threshold;
the height of the terminal falling within a first range; or
the height of the terminal not falling within the first range.

In combination with some embodiments of the second aspect, in some embodiments, the configuration applied by the terminal is a measurement configuration.

In combination with some embodiments of the second aspect, in some embodiments, the second information indicates at least one of:
sending the first message in a case that the configuration applied by the terminal changes;
carrying the first information in the first message that is sent by the terminal every time; or
carrying the first information in the first message that is sent most recently after the configuration applied by the terminal changes.

In the above embodiments, the network device may configure different reporting methods for the terminal, and thus the terminal may report the configuration applied by the terminal based on the different reporting methods, which expands diversity of the configuration of the network device.

In combination with some embodiments of the second aspect, in some embodiments, the second information indicates at least one of:
sending the first message in a case that the configuration applied by the terminal changes;
sending the first message in a case that the terminal has not sent the first information since the terminal is configured to send the first information via a second message;
sending the first message in a case that the configuration currently applied by the terminal is not a default configuration and the terminal has not sent the first information since the terminal is configured to send the first information via a second message; or
sending the first message in a case that the configuration currently applied by the terminal is different from the configuration applied by the terminal that is sent last time.

In the above embodiments, the network device instructs the terminal to send the second message using the second indication information with different functions, which expands diversity of the second indication information and thus ensures configuration accuracy.

In combination with some embodiments of the second aspect, in some embodiments, the method further includes at least one of:
determining whether the configuration applied by the terminal changes based on whether the first information includes first indication information; or
determining whether the configuration applied by the terminal changes based on first indication information included in the first information.

In combination with some embodiments of the second aspect, in some embodiments, determining whether the configuration applied by the terminal changes based on whether the first information includes the first indication information includes at least one of:
the first information indicating that the configuration applied by the terminal changes based on the first information including the first indication information; the first information indicating that the configuration applied by the terminal does not change based on the first information not including the first indication information;
or,
the first information indicating that the configuration applied by the terminal does not change based on the first information including the first indication information; the first information indicating that the configuration applied by the terminal changes based on the first information not including the first indication information.

In combination with some embodiments of the second aspect, in some embodiments, determining whether the configuration applied by the terminal changes based on the first indication information included in the first information includes at least one of:
the first information indicating that the configuration applied by the terminal changes based on the first indication information being a first value; or
the first information indicating that the configuration applied by the terminal does not change based on the first indication information being a second value.

In combination with some embodiments of the second aspect, in some embodiments, the first information includes second indication information, and the second indication information indicates the configuration currently applied by the terminal.

In combination with some embodiments of the second aspect, in some embodiments, the second indication information includes a parameter name corresponding to the configuration currently applied by the terminal;
or,
the second indication information includes a parameter value corresponding to the configuration currently applied by the terminal;
or,
the second indication information includes a configuration identifier corresponding to the configuration currently applied by the terminal.

According to a third aspect, the embodiments of the present disclosure provide a communication method. The method is performed by a communication system, which includes a terminal and a network device. The method includes:
sending, by the terminal, first information to the network device; and
receiving, by the network device, the first information sent by the terminal,
in which the first information indicates at least one of: a configuration applied by the terminal or a change occurring in the configuration applied by the terminal.

In the above embodiments, the terminal may report the information that indicates at least one of the applied configuration or whether the configuration changes, which ensures that the network device may be aware of the configuration currently applied by the terminal and guarantees communication reliability.

In combination with some embodiments of the third aspect, in some embodiments, sending the first information includes at least one of:
sending the first information in a case that the configuration applied by the terminal changes; or
sending the first information in a case that the terminal has not sent the first information.

In combination with some embodiments of the first aspect, in some embodiments, sending the first information in a case that the terminal has not sent the first information includes:
sending the first information in a case that the terminal has not sent the first information since the terminal is configured to send the first information via a first message.

In combination with some embodiments of the third aspect, in some embodiments, the method further includes:
receiving second information, in which the second information is used to configure whether the terminal indicates, via the first information, at least one of: the configuration applied by the terminal or the change occurring in the configuration applied by the terminal.

In combination with some embodiments of the third aspect, in some embodiments, the first information is included in a first message.

In combination with some embodiments of the third aspect, in some embodiments, the first message is a measurement report or the first message is UAI.

In combination with some embodiments of the third aspect, in some embodiments, the method further includes at least one of:
determining whether the configuration applied by the terminal changes, and determining whether a first message that is sent includes the first information; or
determining whether the configuration applied by the terminal changes, and determining a value of the first information included in a first message that is sent.

In combination with some embodiments of the third aspect, in some embodiments, determining whether the configuration applied by the terminal changes, and determining whether the first message that is sent includes the first information includes:
determining that the configuration applied by the terminal changes and the first message includes the first information;
or,
determining that the configuration applied by the terminal does not change and the first message includes the first information.

In combination with some embodiments of the third aspect, in some embodiments, determining whether the configuration applied by the terminal changes, and determining the value of the first information included in the first message that is sent includes at least one of:
determining that the configuration applied by the terminal changes and the first information is a first value; or
determining that the configuration applied by the terminal does not change and the first information is a second value.

In combination with some embodiments of the third aspect, in some embodiments, the first information includes at least one of:
the first information being set to a parameter name corresponding to a configuration currently applied by the terminal;
the first information being set to a parameter value corresponding to a configuration currently applied by the terminal; or
the first information being set to a configuration identifier corresponding to a configuration currently applied by the terminal.

In combination with some embodiments of the third aspect, in some embodiments, the configuration applied by the terminal is a configuration corresponding to a neighboring cell or a non-serving cell.

In combination with some embodiments of the third aspect, in some embodiments, the first information further indicates a corresponding relationship between the configuration corresponding to the neighboring cell or the non-serving cell and a cell identifier of the neighboring cell or the non-serving cell;
or,
the first information further indicates at least one of: a corresponding relationship between a default configuration and a cell identifier of the neighboring cell or the non-serving cell, or a corresponding relationship between a non-default configuration and the neighboring cell or the non-serving cell.

In combination with some embodiments of the third aspect, in some embodiments, determining whether the configuration applied by the terminal changes includes at least one of:
determining whether the configuration applied by the terminal changes based on whether a height of the terminal changes; or
determining whether the configuration applied by the terminal changes from a first configuration to a second configuration.

In combination with some embodiments of the third aspect, in some embodiments, the height includes at least one of:
the height of the terminal being above a first threshold;
the height of the terminal not being above the first threshold;
the height of the terminal being below the first threshold;
the height of the terminal not being below the first threshold;
the height of the terminal falling within a first range; or
the height of the terminal not falling within the first range.

In combination with some embodiments of the third aspect, in some embodiments, the configuration applied by the terminal is a measurement configuration.

According to a fourth aspect, the embodiments of the present disclosure provide a first communication apparatus. The first communication apparatus includes: a sending module, configured to send first information, in which the first information indicates at least one of: a configuration applied by the terminal or a change occurring in the configuration applied by the terminal.

In combination with some embodiments of the fourth aspect, in some embodiments, the sending module is configured to:
send the first information in a case that the configuration applied by the terminal changes; or
send the first information in a case that the terminal has not sent the first information.

In combination with some embodiments of the fourth aspect, in some embodiments, the sending module is configured to: send the first information in a case that the terminal has not sent the first information since the terminal is configured to send the first information via a first message.

In combination with some embodiments of the fourth aspect, in some embodiments, the apparatus further includes:
a receiving module, configured to receive second information, in which the second information is used to configure whether the terminal indicates, via the first information, at least one of: the configuration applied by the terminal or the change occurring in the configuration applied by the terminal.

In combination with some embodiments of the fourth aspect, in some embodiments, the first information is included in a first message.

In combination with some embodiments of the fourth aspect, in some embodiments, the first message is a measurement report or the first message is UAI.

In combination with some embodiments of the fourth aspect, in some embodiments, the apparatus further includes: a processing module, configured to:
determine whether the configuration applied by the terminal changes, and determine whether a first message that is sent includes the first information; or
determine whether the configuration applied by the terminal changes, and determine a value of the first information included in a first message that is sent.

In combination with some embodiments of the fourth aspect, in some embodiments, the processing module is configured to:
determine that the configuration applied by the terminal changes and the first message includes the first information;
or,
determine that the configuration applied by the terminal does not change and the first message includes the first information.

In combination with some embodiments of the fourth aspect, in some embodiments, the processing module is configured to:
determine that the configuration applied by the terminal changes and the first information is a first value; or
determine that the configuration applied by the terminal does not change and the first information is a second value.

In combination with some embodiments of the fourth aspect, in some embodiments, the first information includes at least one of:
the first information being set to a parameter name corresponding to a configuration currently applied by the terminal;
the first information being set to a parameter value corresponding to a configuration currently applied by the terminal; or
the first information being set to a configuration identifier corresponding to a configuration currently applied by the terminal.

In combination with some embodiments of the fourth aspect, in some embodiments, the configuration applied by the terminal is a configuration corresponding to a neighboring cell or a non-serving cell.

In combination with some embodiments of the fourth aspect, in some embodiments, the first information further indicates a corresponding relationship between the configuration corresponding to the neighboring cell or the non-serving cell and a cell identifier of the neighboring cell or the non-serving cell;
or,
the first information further indicates at least one of: a corresponding relationship between a default configuration and a cell identifier of the neighboring cell or the non-serving cell, or a corresponding relationship between a non-default configuration and the neighboring cell or the non-serving cell.

In combination with some embodiments of the fourth aspect, in some embodiments, determining whether the configuration applied by the terminal changes includes at least one of:
determining whether the configuration applied by the terminal changes based on whether a height of the terminal changes; or
determining whether the configuration applied by the terminal changes from a first configuration to a second configuration.

In combination with some embodiments of the fourth aspect, in some embodiments, the height includes at least one of:
the height of the terminal being above a first threshold;
the height of the terminal not being above the first threshold;
the height of the terminal being below the first threshold;
the height of the terminal not being below the first threshold;
the height of the terminal falling within a first range; or
the height of the terminal not falling within the first range.

In combination with some embodiments of the fourth aspect, in some embodiments, the configuration applied by the terminal is a measurement configuration.

According to a fifth aspect, the embodiments of the present disclosure provide a second communication apparatus. The second communication apparatus includes: a receiving module, configured to receive first information, in which the first information indicates at least one of: a configuration applied by a terminal or a change occurring in the configuration applied by the terminal.

In combination with some embodiments of the fifth aspect, in some embodiments, the first information is sent in a case that the configuration applied by the terminal changes;
or
the first information is sent in a case that the terminal has not sent the first information.

In combination with some embodiments of the fifth aspect, in some embodiments, the first information is sent in a case that the terminal has not sent the first information since the terminal is configured to send the first information via a first message.

In combination with some embodiments of the fifth aspect, in some embodiments, the apparatus further includes:
a sending module, configured to send second information, in which the second information is used to configure whether the terminal indicates, via the first information, at least one of: the configuration applied by the terminal or the change occurring in the configuration applied by the terminal.

In combination with some embodiments of the fifth aspect, in some embodiments, the first information is included in a first message.

In combination with some embodiments of the fifth aspect, in some embodiments, the first message is a measurement report or the first message is UAI.

In combination with some embodiments of the fifth aspect, in some embodiments, the apparatus further includes: a processing module, configured to:
determine whether the configuration applied by the terminal changes based on whether a received first message includes the first information; or
determine whether the configuration applied by the terminal changes based on a value of the first information included in a received first message.

In combination with some embodiments of the fifth aspect, in some embodiments, the processing module is configured to:
determine that the configuration applied by the terminal changes based on the first message including the first information;
or,
determine that the configuration applied by the terminal does not change based on the first message including the first information.

In combination with some embodiments of the fifth aspect, in some embodiments, the processing module is configured to:
determine that the configuration applied by the terminal changes based on the first information being a first value; or
determine that the configuration applied by the terminal does not change based on the first information being a second value.

In combination with some embodiments of the fifth aspect, in some embodiments, the first information includes at least one of:
the first information being set to a parameter name corresponding to a configuration currently applied by the terminal;
the first information being set to a parameter value corresponding to a configuration currently applied by the terminal; or
the first information being set to a configuration identifier corresponding to a configuration currently applied by the terminal.

In combination with some embodiments of the fifth aspect, in some embodiments, the configuration applied by the terminal is a configuration corresponding to a neighboring cell or a non-serving cell.

In combination with some embodiments of the fifth aspect, in some embodiments, the first information further indicates a corresponding relationship between the configuration corresponding to the neighboring cell or the non-serving cell and a cell identifier of the neighboring cell or the non-serving cell;
or,
the first information further indicates at least one of: a corresponding relationship between a default configuration and a cell identifier of the neighboring cell or the non-serving cell, or a corresponding relationship between a non-default configuration and the neighboring cell or the non-serving cell.

In combination with some embodiments of the fifth aspect, in some embodiments, determining whether the configuration applied by the terminal changes includes at least one of:
determining, by the terminal, whether the configuration applied by the terminal changes based on whether a height of the terminal changes; or
determining whether the configuration applied by the terminal changes from a first configuration to a second configuration.

In combination with some embodiments of the fifth aspect, in some embodiments, the height includes at least one of:
the height of the terminal being above a first threshold;
the height of the terminal not being above the first threshold;
the height of the terminal being below the first threshold;
the height of the terminal not being below the first threshold;
the height of the terminal falling within a first range; or
the height of the terminal not falling within the first range.

In combination with some embodiments of the fifth aspect, in some embodiments, the configuration applied by the terminal is a measurement configuration.

According to a sixth aspect, the embodiments of the present disclosure provide a communication device. The communication device includes: one or more processors; one or more memories for storing instructions. The one or more processors are configured to invoke instructions to cause the communication device to implement the communication method in the first aspect, the communication method in the second aspect, and the communication methods in optional implementations of the first aspect and the second aspect.

According to a seventh aspect, the embodiments of the present disclosure provide a communication system. The communication system includes: a terminal; and a network device. The terminal is configured to implement the method in the first aspect and optional implementations of the first aspect, and the network device is configured to implement the method in the second aspect and optional implementations of the second aspect.

According to an eighth aspect, the embodiments of the present disclosure provide a storage medium for storing instructions. When the instructions are running on a communication device, the communication device is caused to implement the communication method in the first aspect and optional implementations of the first aspect, or the communication method in the second aspect and optional implementations of the second aspect.

According to a ninth aspect, the embodiments of the present disclosure provide a program product. When the program product is executed by a communication device, the communication device is caused to implement the method in the first aspect and optional implementations of the first aspect, or the method in the second aspect and optional implementations of the second aspect.

According to a tenth aspect, the embodiments of the present disclosure provide a computer program. When the computer program is running on a computer, the computer is caused to implement the method in the first aspect and optional implementations of the first aspect, or the method in the second aspect and optional implementations of the second aspect.

It may be understood that the first communication apparatus, the second communication apparatus, the communication device, the communication system, the storage medium, the program product, and the computer program are all used to implement the method in the embodiments of the present disclosure. Therefore, regarding beneficial effects they may achieve, reference may made be to the beneficial effects in the corresponding methods, which will not be repeated here.

The embodiments of the present disclosure provide a communication method, a communication apparatus, a communication device, and a storage medium. In some embodiments, terms such as “communication method” and “information processing method” may be used interchangeably, terms such as “information transmitting apparatus”, “information processing apparatus”, and “communication apparatus” may be used interchangeably, and terms such as “information processing system” and “communication system” may be used interchangeably.

The embodiments of the present disclosure are not exhaustive, but are only illustrative, and are not intended to be a specific limitation on the protection scope of the present disclosure. In the absence of contradiction, each step in a certain embodiment can be implemented as an independent embodiment, and respective steps can be arbitrarily combined. For example, a solution after removing some steps in a certain embodiment can also be implemented as an independent embodiment, and the order of the steps in a certain embodiment can be arbitrarily exchanged. In addition, the optional implementations in a certain embodiment can be arbitrarily combined; in addition, respective embodiments can be arbitrarily combined, for example, some or all steps of different embodiments can be arbitrarily combined, and a certain embodiment can be arbitrarily combined with the optional implementations of other embodiments.

In each embodiment of the present disclosure, unless otherwise specified or there is a logical conflict, the terms and/or descriptions between the embodiments are consistent and can be referred to each other, and the technical features in different embodiments can be combined to form a new embodiment based on their internal logical relationships.

The terms used in the embodiments of the present disclosure are only for the purpose of describing specific embodiments and are not intended to limit the present disclosure.

In the embodiments of the present disclosure, unless otherwise specified, elements expressed in the singular form, such as “a”, “an”, “the”, “above”, “said”, “aforementioned”, “this”, etc., may mean “one and only one”, or “one or more”, “at least one”, etc. For example, when using articles such as “a”, “an”, “the” in English translation, the noun after the article may be understood as a singular expression or a plural expression.

In the embodiments of the present disclosure, “plurality” refers to two or more.

In some embodiments, the terms “at least one of”, “one or more”, “a plurality of”, “multiple” etc. may be used interchangeably.

In the embodiments of the present disclosure, descriptions such as “at least one of A, B, C . . . ”, “A and/or B and/or C . . . ”, etc. include the case where any one of A, B, C . . . exists alone, and also include any combination of any multiple ones of A, B, C . . . , and each case may exist alone. For example, “at least one of A, B, or C” includes the case where A exists alone, the case where B exists alone, the case where C exists alone, the combination of A and B, the combination of A and C, the combination of B and C, and the combination of A, B, and C. For example, A and/or B includes the case where A exists alone, the case where B exists alone, and the combination of A and B.

In some embodiments, the descriptions such as “in one case, A; in another case, B”, “in response to one case, A; in response to another case, B”, etc. may include the following technical solutions according to situations: A is executed independently of B, that is, in some embodiments, A; B is executed independently of A, that is, in some embodiments, B; A and B are selectively executed, that is, in some embodiments, one is selected from A and B to be executed; both A and B are executed, that is, in some embodiments, A and B. When there are more branches such as A, B, C, etc., the above is applicable.

The prefixes such as “first” and “second” in the embodiments of the present disclosure are only used to distinguish different descriptive objects, and do not constitute restrictions on the position, order, priority, quantity or content of the descriptive objects. For the statement of the descriptive objects, reference may be made to the description in the context of the claims or embodiments, and it should not constitute redundant restrictions due to the use of prefixes. For example, if the descriptive object is “field”, the ordinal number before the “field” in the “first field” and the “second field” does not limit the position or order between the “fields”, and the terms “first” and “second” do not limit whether the “fields” they modify are in the same message, nor do they limit the order of the “first field” and the “second field”. For another example, if the descriptive object is “level”, the ordinal number before the “level” in the “first level” and the “second level” does not limit the priority between the “levels”. For another example, the number of descriptive objects is not limited by the ordinal number, and can be one or more. Taking the “first apparatus” as an example, the number of “apparatuses” can be one or more. In addition, the objects modified by different prefixes may be the same or different. For example, if the descriptive object is “apparatus”, then the “first apparatus” and the “second apparatus” may be the same device or different apparatuses, and their types may be the same or different. For another example, if the descriptive object is “information”, then the “first information” and the “second information” may be the same information or different information, and their contents may be the same or different.

In some embodiments, “including A”, “comprising A”, “used to indicate A”, and “carrying A” can be interpreted as directly carrying A or indirectly indicating A.

In some embodiments, the terms such as “in response to . . . ”, “in response to determining . . . ”, “in the case of . . . ”, “at the time of . . . ”, “when . . . ”, “if . . . ”, “if . . . ”, etc. can be used interchangeably.

In some embodiments, the terms such as “greater than”, “greater than or equal to”, “not less than”, “more than”, “more than or equal to”, “not less than”, “higher than”, “higher than or equal to”, “not lower than”, and “above” can be replaced with each other, and the terms such as “less than”, “less than or equal to”, “not greater than”, “less than”, “less than or equal to”, “no more than”, “lower than”, “lower than or equal to”, “not higher than”, and “below” can be replaced with each other.

In some embodiments, the apparatus, etc. can be interpreted as physical or virtual, and their names are not limited to the names recorded in the embodiments. The terms such as “apparatus”, “equipment”, “device”, “circuit”, “network element”, “node”, “function”, “unit”, “section”, “system”, “network”, “chip”, “chip system”, “entity”, and “subject” can be used interchangeably.

In some embodiments, the terms such as “access network device (AN device)”, “radio access network device (RAN device)”, “base station (BS)”, “radio base station”, “fixed station”, “node”, “access point”, “transmission point (TP)”, “reception point (RP)”, “transmission/reception point (TRP)”, “panel”, “antenna panel”, “antenna array”, “cell”, “macro cell”, “small cell”, “femto cell”, “pico cell”, “sector”, “cell group”, “carrier”, “component carrier”, “bandwidth part (BWP)” and the like can be used interchangeably.

In some embodiments, the terms such as “terminal”, “terminal device”, “user equipment (UE)”, “user terminal”, “mobile station (MS)”, “mobile terminal (MT)”, “subscriber station”, “mobile unit”, “subscriber unit”, “wireless unit”, “remote unit”, “mobile device”, “wireless device”, “wireless communication device”, “remote device”, “mobile subscriber station”, “access terminal”, “mobile terminal”, “wireless terminal”, “remote terminal”, “handset”, “user agent”, “mobile client”, “client” and the like can be used interchangeably.

In some embodiments, the access network device, the core network device, or the network device can be replaced by the terminal. For example, various embodiments of the present disclosure can also be applied to a structure in which the communication between the access network device, the core network device, or the network device and the terminal is replaced by the communication between multiple terminals (for example, it can also be referred to as device-to-device (D2D), vehicle-to-everything (V2X), etc.). In this case, the terminal can be set to have a structure that has all or part of functions of the access network device. In addition, the language such as “uplink” and “downlink” can also be replaced by the language corresponding to the communication between the terminals (for example, “side”). For example, the uplink channel, the downlink channel, etc. can be replaced by the side channel, and the uplink, the downlink, etc. can be replaced by the side link.

In some embodiments, the terminal may be replaced by the access network device, the core network device, or the network device. In this case, the access network device, the core network device, or the network device may also be configured to have a structure that has all or part of functions of the terminal.

In some embodiments, the names of information, etc. are not limited to the names recorded in the embodiments, and terms such as “information”, “message”, “signal”, “signaling”, “report”, “configuration”, “indication”, “instruction”, “command”, “channel”, “parameter”, “domain”, “field”, “symbol”, “symbol”, “code element”, “codebook”, “codeword”, “codepoint”, “bit”, “data”, “program”, and “chip” can be used interchangeably.

In some embodiments, the terms such as “uplink”, “uplink”, “physical uplink” can be interchangeable, and terms such as “downlink”, “downlink”, “physical downlink” can be interchangeable, and the terms such as “side”, “sidelink”, “side communication”, “sidelink communication”, “direct connection”, “direct link”, “direct communication”, “direct link communication” can be interchangeable.

In some embodiments, the terms “downlink control information (DCI)”, “downlink (DL) assignment”, “DL DCI”, “uplink (UL) grant”, “UL DCI” and the like may be used interchangeably.

In some embodiments, the terms such as “physical downlink shared channel (PDSCH)”, “DL data” and the like can be interchangeable, and the terms such as “physical uplink shared channel (PUSCH)”, “UL data” and the like can be interchangeable.

In some embodiments, the terms “radio”, “wireless”, “radio access network (RAN)”, “access network (AN)”, “RAN-based” and the like may be used interchangeably.

In some embodiments, the terms “search space”, “search space set”, “search space configuration”, “search space set configuration”, “control resource set (CORESET)”, “CORESET configuration” and the like may be interchangeable.

In some embodiments, terms such as “synchronization signal (SS)”, “synchronization signal block (SSB)”, “reference signal (RS)”, “pilot”, “pilot signal” and the like can be used interchangeably.

In some embodiments, the terms such as “moment”, “time point”, “time”, “time position” and the like can be interchangeable, and the terms such as “duration”, “period”, “time window”, “window”, “time” and the like can be interchangeable.

In some embodiments, the terms “component carrier (CC)”, “cell”, “frequency carrier”, “carrier frequency” and the like may be used interchangeably.

In some embodiments, terms such as “resource block (RB)”, “physical resource block (PRB)”, “sub-carrier group (SCG)”, “resource element group (REG)”, “PRB pair”, “RB pair”, “resource element (RE)” and the like can be used interchangeably.

In some embodiments, the terms such as “wireless access scheme”, “waveform”, etc. may be used interchangeably.

In some embodiments, the terms such as “precoding”, “precoder”, “weight”, “precoding weight”, “quasi-co-location (QCL)”, “transmission configuration indication (TCI) state”, “spatial relation”, “spatial domain filter”, “transmission power”, “phase rotation”, “antenna port”, “antenna port group”, “layer”, “the number of layers”, “rank”, “resource”, “resource set”, “resource group”, “beam”, “beam width”, “beam angular degree”, “antenna”, “antenna element”, “panel” and the like can be used interchangeably.

In some embodiments, the terms such as “frame”, “radio frame”, “subframe”, “slot”, “sub-slot”, “mini-slot”, “symbol”, “symbol”, “transmission time interval (TTI)” and so on can be used interchangeably.

In some embodiments, “obtain”, “acquire”, “get”, “receive”, “transmit”, “bidirectional transmission”, “send and/or receive” can be interchangeable, and can be interpreted as receiving from other entities, obtaining from a protocol, obtaining by self-processing, autonomous implementation, etc.

In some embodiments, the terms such as “send”, “transmit”, “report”, “issue”, “transmit”, “bi-directionally transmit”, “send and/or receive” and the like can be used interchangeably.

In some embodiments, “predetermined” or “preset” may be interpreted as being pre-specified in a protocol, etc., or may be interpreted as an apparatus performing a pre-set action, etc.

In some embodiments, “determining” can be interpreted as “judging”, “deciding”, “judging”, “calculating”, “computing”, “processing”, “deriving”, “investigating”, “searching”, “looking up”, “searching”, “inquiring”, “ascertaining”, “receiving”, “transmitting”, “inputting”, “outputting, “accessing”, “resolving”, “selecting”, “choosing”, “establishing”, “comparing”, “assuming”, “expecting”, “considering”, “broadcasting”, “notifying”, “communicating”, “forwarding”, “configuring”, “reconfiguring”, “allocating”, “mapping”, “assigning”, etc., but is not limited to the above.

In some embodiments, the determination or judgment may be performed by a value represented by 1 bit (0 or 1), or by a true/false value (Boolean value) represented by true or false, or by comparison of numerical values (for example, comparison with a predetermined value), but is not limited thereto.

In some embodiments, “network” may be interpreted as apparatuses included in the network (e.g., access network device, core network device, etc.).

In some embodiments, “not expecting to receive” can be interpreted as not receiving on time domain resources and/or frequency domain resources, or as not performing subsequent processing on the data after receiving the data; “not expecting to send” can be interpreted as not sending, or as sending but not expecting the recipient to respond to the sent content.

In some embodiments, the acquisition of data, information, etc. may comply with the laws and regulations of the country where the data is obtained.

In some embodiments, data, information, etc. may be obtained with the user's consent.

In addition, each element, each row, or each column in the table of the embodiments of the present disclosure may be implemented as an independent embodiment, and the combination of any elements, any rows, or any columns may also be implemented as an independent embodiment.

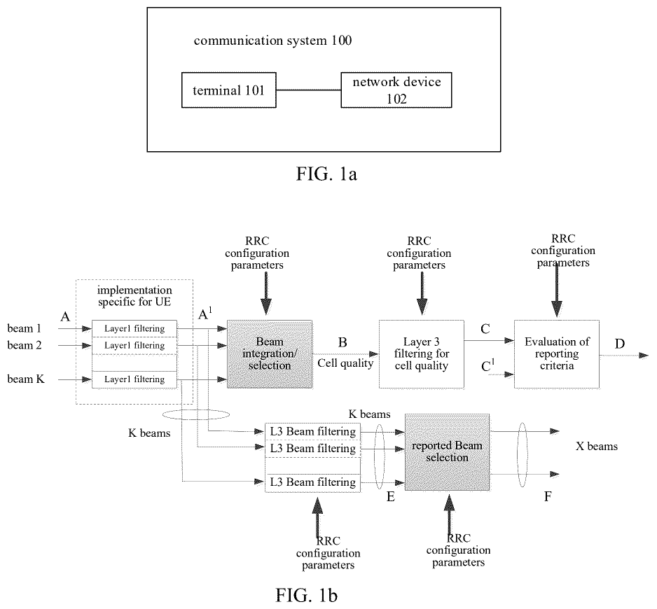

FIG. 1a is a schematic diagram of an architecture of a communication system according to an embodiment of the present disclosure.

As shown in FIG. 1a, the communication system 100 may include a terminal 101 and a network device 102.

In some embodiments, the terminal 101, for example, may include at least one of a mobile phone, a wearable device, an Internet of Things device, a car with a communication function, a smart car, a Pad, a computer with a wireless receiving and sending function, a virtual reality (VR) terminal, an augmented reality (AR) terminal, a wireless terminal in industrial control, a wireless terminal in self-driving, a wireless terminal in remote medical surgery, a wireless terminal in smart grid, a wireless terminal in transportation safety, a wireless terminal in smart city, or a wireless terminal in smart home, but is not limited thereto.

In some embodiments, the network device 102 may include at least one of an access network device or a core network device.

In some embodiments, the access network device may be, for example, a node or device that accesses a terminal to a wireless network. The access network device may include at least one of an evolved NodeB (eNB), a next generation eNB (ng-eNB), a next generation NodeB (gNB), a node B (NB), a home node B (HNB), a home evolved nodeB (HeNB), a wireless backhaul device, a radio network controller (RNC), a base station controller (BSC), a base transceiver station (BTS), a base band unit (BBU), a mobile switching center, a base station in a 6G communication system, an open base station (Open RAN), a cloud base station (Cloud RAN), a base station in other communication systems, or an access node in a wireless fidelity (WiFi) system, but is not limited thereto.

In some embodiments, the technical solution of the present disclosure may be applicable to an Open RAN architecture. In this case, the interfaces between or within the access network devices involved in the embodiments of the present disclosure may become internal interfaces of the Open RAN, and the processes and information interactions between these internal interfaces may be implemented through software or programs.

In some embodiments, the access network device may include a central unit (CU) and a distributed unit (DU), in which the CU may also be called a control unit. A protocol layer of the access network device may be divided by adopting the CU-DU structure. Some functions of the protocol layer are centrally controlled by the CU, and some or all of remaining functions of the protocol layer are distributed in the DU which is centrally controlled by the CU, but is not limited thereto.

In some embodiments, the core network device may be a device including one or more network elements, or may be a plurality of devices or device groups, each including all or part of one or more network elements. The network element may be virtual or physical. The core network may include, for example, at least one of an Evolved Packet Core (EPC), a 5G Core Network (5GCN), or a Next Generation Core (NGC).

It can be understood that the communication system described in the embodiments of the present disclosure aims to more clearly illustrate the technical solution of the embodiments of the present disclosure, and does not constitute a limitation on the technical solution proposed in the embodiments of the present disclosure. A person skilled in the art can know that with the evolution of the system architecture and the emergence of new business scenarios, the technical solution proposed in the embodiments of the present disclosure are also applicable to similar technical problems.

The following embodiments of the present disclosure may be applied to the communication system 100 or part of the subjects shown in FIGS. 1a-1b, but are not limited thereto. The subjects shown in FIGS. 1a-1b are examples, and the communication system may include all or part of the subjects in FIGS. 1a-1b, or may include other subjects other than those shown in FIGS. 1a-1b, and the number and form of the subjects are arbitrary, and the connection relationships between the subjects are examples, and the subjects may be connected or disconnected, and the connection may be in any manner, which may be a direct connection or an indirect connection, and may be a wired connection or a wireless connection.

The embodiments of the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 5G new radio (NR), future radio access (FRA), new radio access technology (RAT), new radio (NR), new radio access (NX), future generation radio access (FX), Global System for Mobile communications (GSM (registered trademark)), CDMA2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), Public Land Mobile Network (PLMN) network, Device-to-Device (D2D) system, Machine-to-Machine (M2M) system, Internet of Things (IoT) system, Vehicle-to-Everything (V2X), systems using other communication methods, and next-generation systems based on them. In addition, multiple systems can also be combined (for example, a combination of LTE or LTE-A and 5G, etc.) for application.

The embodiments of the present disclosure provide a communication method. The communication method in the present disclosure will be described below.

In some embodiments, the terminal in the embodiments of the present disclosure may perform radio resource management (RRM) measurement and report an obtained measurement result to a network device. The terminal may be in a mobile state, and the movement of the terminal causes a channel condition around the terminal to change constantly. To support mobility of the terminal and promptly obtain channel conditions of cells currently around the terminal, the network device configures the terminal to perform RRM measurement. In addition, the state of the terminal includes an idle state, an inactive state, and a connected state. When the terminal is in the idle state or the inactive state, the terminal autonomously performs cell selection or cell reselection based on the RRM measurement result. When the terminal is in the connected state, the terminal reports the RRM measurement result to the network device to assist the network device in deciding whether to perform cell handover. During a measurement process while the terminal is in the connected state, the network device of the mobile communication system sends measurement configuration information to the terminal via a radio resource control (RRC) signaling. The terminal performs intra-frequency/inter-frequency/inter-system measurement according to the measurement configuration information and reports the measurement result to the network device. The measurement is described in three aspects below, including measurement configuration, measurement execution, and information transmission.

### Measurement Configuration

The network device uses an RRC reconfiguration process for the measurement configuration. The measurement configuration information includes: a measurement object, a reporting configuration, a measurement identification, a measurement initiation threshold, a measurement gap, measurement gap allocation, and other information.

Associated configuration is performed for each set of measurements per index. The overall index is a measurement identification. All measurements are arranged strictly according to an association relationship of measurement identifications and are sent to the terminal by the network device. Each measurement identification is simultaneously linked to one measurement object identification and one reporting configuration identification, which represents a combination of a measurement object that is needed to be measured and a reporting configuration. A measurement object and a reporting configuration that are not linked to the measurement identification may also be delivered to the terminal, but the terminal will not perform any form of measurement for these configurations. It needs to be noted that each measurement identification may only be associated with one measurement object identification and one reporting configuration identification.

### Measurement Execution

Referring to FIG. 1b, the terminal performs layer 1 filtering on K beams to obtain K beams after the layer 1 filtering, performs beam integration/selection based on RRC configuration parameters, performs layer 3 filtering based on a cell quality, and performs an evaluation of a reporting criteria. In addition, the terminal also performs the layer 3 beam filtering on the obtained K beams after the layer 1 filtering based on the RRC configuration parameters, reports selected beams, and obtains X beams, where X is not greater than K.

### Measurement Reporting

The terminal performs the measurement according to the measurement configuration sent by the network device to obtain a cell-level measurement result, and then performs the evaluation of the reporting criteria. Generally, the measurement reporting may be classified into event-triggered reporting and periodic reporting according to a reporting evaluation criteria. The used reporting evaluation criteria are determined by the reporting configuration sent to a user equipment (UE).

Event reporting: events supported in the mobile communication system include an intra-system event and an inter-system event, in which the intra-system event supported in the mobile communication system includes one or more of:
(1) a measurement result of the serving cell being greater than a threshold;
(2) a measurement result of the serving cell being less than a threshold;
(3) a measurement result of a neighboring cell being better than a measurement result of a special cell (SpCell) (which may be a primary cell (PCell) or a primary secondary cell (PSCell));
(4) a measurement result of a neighboring cell being greater than a threshold;
(5) a measurement result of an SpCell (which may be a PCell or a PSCell) being less than threshold 1, and simultaneously a measurement result of a neighboring cell being greater than threshold 2; and
(6) a measurement result of a neighboring cell being better than a measurement result of a certain secondary cell (SCell).

The inter-system event supported by the mobile communication system includes one or more of:
(1) a measurement result of an inter-system neighboring cell being greater than a threshold; and
(2) a measurement result of a PCell being less than threshold 1, and simultaneously a measurement result of an inter-RAT neighboring cell being greater than threshold 2.

### Periodic Reporting

After the measurement configuration of the network device is completed, the terminal may perform the measurement on the corresponding frequency points according to configuration content and send a measurement report according to a specified reporting period and a specified reporting interval. If a triggering type is “periodic”, after the maximum number of reporting is reached, the terminal may autonomously delete a corresponding measurement identification in measurement configuration variables. The reporting configuration corresponding to the criterion includes:
(1) the triggering type being “periodic”;
(2) the number of reporting being greater than 1; and
(3) the reporting interval being valid, and the network setting a reporting period timer according to a configured interval parameter.

If a reporting condition is met, the terminal may trigger reporting of the measurement report. Content of the measurement report includes following aspects:
(1) a measurement identification, via the identification, the network learns information in a plurality of aspects from a measurement configuration stored by the network, including a measurement object corresponding to the reporting, a measurement event threshold triggered by the event, a purpose of periodic triggering, etc.;
(2) measurement results of all available serving cells;
(3) a best measurement result of the neighboring cell on each serving frequency point that is optionally carried according to the reporting configuration;
(4) a measurement result of the neighboring cell that meets the triggering condition.

Optionally, the terminal in the embodiments of the present disclosure may also be an unscrewed aerial vehicle (UAV) device, that is, the present disclosure is applied to a field of UAV. The UAV device may perform various UAV operations, personal entertainment for flight experiences, a cargo delivery, etc. Based on these services, remote control and a data transmission capability are keys to enhance UAV services.

In some embodiments, a long term evolution (LTE) system proposes that the UAV device may perform measurement reporting and height reporting based on a height.

Optionally, in new radio (NR), applications suitable for UAVs are more diversified. For terminals of UAVs, there is a requirement of low latency and transmission rate. Therefore, on the basis of LTE UAVs, NR UAVs need to be enhanced.

In UAVs, due to a height of the UAV terminal, compared to a ground terminal, the UAV terminal has more line of sight (LOS) connections. Therefore, for an aerial UAV terminal, a measured signal does not change significantly for different distances, and the aerial terminal may receive a signal from a base station that are far away, so that the UAV terminal may suffer from or result in more severe interference than the ground terminal, which increases the measurement reporting of the aerial terminal, and poses a great challenge to mobility management of the UAV terminal.

A signal strength of the signal received by the ground terminal depends on a distance between the ground terminal and the base station and an obstacle. However, this kind of mobility management for the ground terminal is not suitable for the aerial terminal when the UAV ascends or descends. On the one hand, transmission paths between the aerial terminal and the base station are almost all LOS paths; on the other hand, when the UAV moves vertically, a distance between the aerial terminal and the base station changes little. In this case, if mobility of the UAV terminal still relies on the legacy mobility management, a radio link failure (RLF) may occur due to a handover that is too late.

Accordingly, an enhancement supporting height-based multi-configuration is proposed, that is, the terminal determines the measurement configuration that needs to be applied based on height information. For example, if the height of the terminal belongs to range 1, the terminal applies a corresponding configuration 1; if the height of the terminal belongs to range 2, the terminal applies a corresponding configuration 2. Configuration 1 and configuration 2 may correspond to one or more parameters. For example, configuration 1 corresponds to measurement object 1, configuration 2 corresponds to measurement object 2; or both configuration 1 and configuration 2 correspond to the same measurement object having two parameters or parameter values.

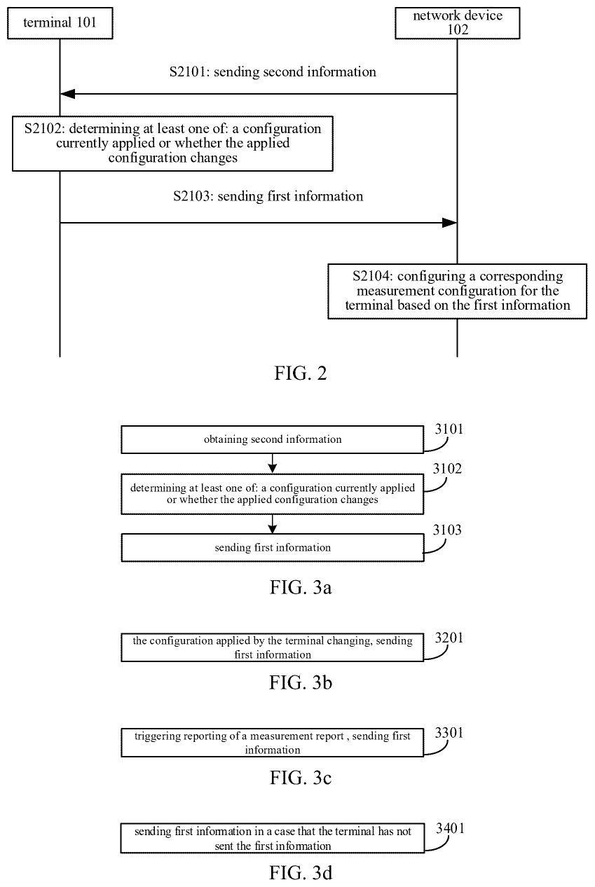

FIG. 2 is an interactive schematic diagram of a communication method according to an embodiment of the present disclosure. As shown in FIG. 2, the embodiment of the present disclosure relates to a communication method which is performed by a communication system 100. The method includes the following steps.

At S2101, a network device 102 sends second information to a terminal 101.

In some embodiments, the terminal 101 receives the second information sent by the network device 102.

In some embodiments, the second information is used to configure whether the terminal 101 indicates, via first information, at least one of: a configuration applied by the terminal 101 or a change occurring in the configuration applied by the terminal 101.

In some embodiments, the second information is configured to request the terminal 101 to indicate, via the first information, at least one of: the configuration applied by the terminal 101 or the change occurring in the configuration applied by the terminal 101.

In some embodiments, the second information is configured to instruct the terminal 101 not to indicate, via the first information, at least one of: the configuration applied by the terminal 101 or the change occurring in the configuration applied by the terminal 101.

In the embodiments of the present disclosure, the terminal 101 does not report at least one of the configuration applied by the terminal 101 or whether the configuration applied by the terminal 101 changes to the network device 102. For this purpose, the network device 102 may send the second information to the terminal 101, to request, via the second information, the terminal 101 to report at least one of: the configuration applied by the terminal 101 or whether the configuration applied by the terminal 101 changes, so that the terminal 101 may report based on a configuration of the network device 102.

For example, if the network device 102 configures that, via the second information, the terminal 101 indicates the configuration applied by the terminal 101 via the first information, then the terminal 101 may inform the network device 102 of the configuration applied by the terminal 101 via the first information. For another example, if the network device 102 configures that, via the second information, the terminal 101 indicates that the configuration applied by the terminal 101 changes via the first information, then the terminal 101 may inform the network device 102 that the configuration applied by the terminal 101 changes via the first information.

Optionally, the terminal 101 adjusts the configuration applied by the terminal 101 based on a height, that is to say, when the height of the terminal 101 changes, there is a situation where the applied configuration changes.

It needs to be noted that the configuration applied by the terminal 101 in the embodiments of the present disclosure may also be referred to as a configuration used by the terminal 101, a configuration adopted by the terminal 101, a configuration executed by the terminal 101, or other descriptions, which are not limited in the embodiments of the present disclosure.

In some embodiments, the second information is used to configure that the terminal 101 sends the first information via a first message. Optionally, the first message is a measurement report or UAI. The present disclosure does not limit the first message, and the first message may also be other messages. It may also be understood that the second information is used to configure that the terminal 101 sends the first information via the measurement report. Or, the second information is used to configure that the terminal 101 sends the first information via the UAI.

In some embodiments, the second information instructs the terminal 101 to report the first message in response to the change occurring in the applied configuration. Optionally, the first message includes the first information. That is to say, in the embodiments of the present disclosure, the second information instructs the terminal 101 to immediately send the first message including the first information if the terminal 101 determines that the applied configuration changes.

Optionally, the second information is carried in or included in a measurement configuration. Optionally, the measurement configuration includes at least one of: a measurement object configuration, a measurement identification configuration, or a reporting configuration. Optionally, the second information is a fourth value, or is another value, which is not limited in the embodiments of the present disclosure. For example, if the second information carried in the configuration is 1, the terminal 101 is instructed to report the first message once in response to the change occurring in the applied configuration

Optionally, the first message is a measurement report. That is to say, the terminal 101 sends the first information to the network device 102 by carrying the first information in the measurement report, or the terminal 101 includes the first information in the measurement report and then sends the measurement report including the first information to the network device 102.

In other embodiments, the second information instructs the terminal 101 to carry the first information in the first message reported each time.

In the embodiments of the present disclosure, the terminal 101 carries the first information in the first message each time the terminal 101 needs to report the first message. Optionally, the second information is carried in the configuration. Optionally, the configuration includes at least one of: a measurement object configuration, a measurement identification configuration, or a reporting configuration. Optionally, the second information is a fourth value, or is another value, which is not limited in the embodiments of the present disclosure. For example, if the second information carried in the configuration is 0, the terminal 101 is instructed to carry the first information in the first message reported each time.

In some embodiments, the first message is a measurement report. That is to say, the terminal 101 sends the first information to the network device 102 by carrying the first information in the measurement report that is reported each time.

In some embodiments, the second information instructs the terminal 101 to carry the first information in the first message reported most recently in response to the change occurring in the applied configuration.

In some embodiments, the second information indicates instructs the terminal 101 to send a second message in a case that the terminal 101 has not sent the first information since the terminal 101 is configured to send the first information via the second message. Optionally, the second message includes the first information.

In the embodiments of the present disclosure, if the terminal 101 is configured to send the first information via the second message, and the terminal 101 has not sent the first information since the terminal 101 is configured to send the first information via the second message, the second message is sent. Optionally, the first information indicates a configuration currently applied by the terminal 101, or indicates whether a configuration currently applied by the terminal 101 is a default configuration, or indicates whether a configuration applied by terminal 101 changes. For example, the default configuration is specified by a protocol, or configured by the network device 102, or configured in other ways. For another example, if the first information is 0, it indicates that the configuration applied by the terminal 101 does not change; and if the first information is 1, it indicates that the configuration applied by the terminal 101 changes. Or, if the first information is 1, it indicates that the configuration applied by the terminal 101 does not change; and if the first information is 0, it indicates that the configuration applied by the terminal 101 changes.

In some embodiments, the second information indicates instructs the terminal 101 to send the second message in a case that the configuration currently applied by the terminal 101 is not a default configuration, and the terminal 101 has not sent the first information since the terminal 101 is configured to send the first information via the second message. The second message includes the first information.

Optionally, the default configuration is specified by a protocol, or configured by the network device 102, or configured in other ways. Optionally, the first information indicates the configuration currently applied by the terminal 101, or indicates whether the configuration currently applied by the terminal 101 is a default configuration, or indicates whether the configuration applied by the terminal 101 changes. For another example, if the first information is 0, it indicates that the configuration applied by the terminal 101 does not change; and if the first information is 1, it indicates that the configuration applied by the terminal 101 changes. Or, if the first information is 1, it indicates that the configuration applied by the terminal 101 does not change; and if the first information is 0, it indicates that that the configuration applied by the terminal 101 changes.

In some embodiments, the second information instructs the terminal 101 to send the second message in a case that the configuration currently applied by the terminal 101 is different from a configuration applied by the terminal 101 that was last reported. The second message includes the first information.

Optionally, that the configuration currently applied by the terminal 101 being different from the configuration applied by the terminal 101 that was last reported further includes: the configuration currently applied by the terminal 101 being different from the configuration applied by the terminal 101 that was last reported. For example, the configuration currently applied by the terminal 101 is a default configuration, while the configuration applied by the terminal 101 last time is a non-default configuration. For another example, the configuration currently applied by the terminal 101 is a non-default configuration, while the configuration applied by the terminal 101 last time is a default configuration.

Optionally, the default configuration is specified by a protocol, or configured by the network device 102, or configured in other ways. Optionally, the first information indicates the configuration currently applied by the terminal 101, or indicates whether the configuration currently applied by the terminal 101 is a default configuration, or indicates whether the configuration applied by the terminal 101 changes. For another example, if the first information is 0, it indicates that the configuration applied by the terminal 101 does not change; and if the first information is 1, it indicates that the configuration applied by the terminal 101 changes. Or, if the first information is 1, it indicates that the configuration applied by the terminal 101 does not change; and if the first information is 0, it indicates that the configuration applied by the terminal 101 changes.

It needs to be noted that the second information in the embodiments of the present disclosure is an RRC message, or another type of messages. For example, the RRC message is an RRCReconfiguration message. For example, it is configured in OtherConfig information. The OtherConfig includes indication information of the applied configuration of a SetupRelease category. In response to the UE receiving the OtherConfig, if the OtherConfig includes a reporting configuration indicated by the applied configuration, if the configuration is set to be “setup”, it is considered that the UE is configured to report information related to the configuration applied by the UE; if the configuration is not set to be “setup” (for example, set to be “release”), it is considered that the UE is not configured to report information related to the configuration applied by the UE.

In some embodiments, the second message is UAI. That is to say, the terminal 101 reports the first information by reporting the UAI.

It needs to be noted that S2101 in the embodiments of the present disclosure is an optional step, so that S2101 may not be performed and S2102 may be directly performed. It may also be understood that the network device 102 does not need to send the second information to the terminal 101, and the terminal 101 needs to report the first information to the network device 102 by default.

At S2102, the terminal 101 determines at least one of: a configuration that is currently applied or whether the configuration that is applied changes.

In some embodiments, the terminal 101 needs to detect the configuration applied by the terminal 101, or detect whether the configuration applied by the terminal 101 changes, to facilitate subsequent execution of S2103 by the terminal 101.

At S2103, the terminal 101 sends first information to the network device 102.

In some embodiments, the network device 102 receives the first information sent by the terminal 101.

In some embodiments, the first information indicates at least one of: a configuration applied by the terminal 101 or a change occurring in the configuration applied by the terminal 101. In other embodiments, the first information indicates parameters sent by the terminal 101. That is to say, the first information is information for the terminal 101 to send the parameters applied by the terminal 101.

Optionally, the first information may correspond to one parameter (or one field) or a plurality of parameters or fields, or, the first information may also correspond to an information element (IE).

Optionally, an explanation of how the first information indicates the change occurring in the configuration applied by the terminal 101 will be described below.

First type: the first information includes first indication information, and the first information indicates that the configuration applied by the terminal 101 changes.

In some embodiments, if the first information does not include the first indication information, then the first information indicates that the configuration applied by the terminal 101 does not change. For example, if there is the first indication information in the first information, then the first information indicates that the configuration applied by the terminal 101 changes. Existence of the first indication information in the first information includes that the first indication information in the first information is 1. If there is no first indication information in the first information, then the first information indicates that the configuration applied by the terminal 101 does not change. Inexistence of the first indication information in the first information includes that a bit of the first indication information in the first information is empty, or, the first indication information in the first information is 0.

Second type: the first information includes the first indication information, and the first information indicates that the configuration applied by the terminal 101 does not change.

In some embodiments, if the first information does not include the first indication information, then the first information indicates that the configuration applied by the terminal 101 changes. For example, if there is the first indication information in the first information, then the first information indicates that the configuration applied by the terminal 101 does not change. Existence of the first indication information in the first information includes that the first indication information in the first information is 1. If there is no first indication information in the first information, then the first information indicates that the configuration applied by the terminal 101 changes. Inexistence of the first indication information in the first information includes that a bit of the first indication information in the first information is empty, or, the first indication information in the first information is 0.

Third type: the first information includes the first indication information and the first indication information is a first value, and the first information indicates that the configuration applied by the terminal 101 changes.

For example, if the first value is 1, the first indication information indicates that the configuration applied by the terminal 101 changes; for another example, if the first value is 0, the first indication information indicates that the configuration applied by the terminal 101 changes. Or, the first value is another value, which is not limited in the embodiments of the present disclosure.

Fourth type: the first information includes the first indication information and the first indication information is a second value, and the first information indicates that the configuration applied by the terminal 101 does not change.

For example, if the second value is 1, the first indication information indicates that the configuration applied by the terminal 101 does not change; for another example, if the second value is 0, the first indication information indicates that the configuration applied by the terminal 101 does not change. Or, the second value is another value, which is not limited in the embodiments of the present disclosure.

In some embodiments, the first information includes second indication information, and the second indication information indicates the configuration currently applied by the terminal 101.

Optionally, the second indication information includes a parameter name corresponding to the configuration currently applied by the terminal 101. For example, the parameter name is configuration 1, configuration 2, or other names, which is not limited in the embodiments of the present disclosure. For another example, configuration 1 corresponds to parameter A, and configuration 2 corresponds to parameter B.

Optionally, the second indication information includes a parameter value corresponding to the configuration currently applied by the terminal 101. For example, configuration 1 corresponds to a first value of the parameter A, and configuration 2 corresponds to a second value b of the parameter A.

Optionally, the second indication information includes a configuration identifier corresponding to the configuration currently applied by the terminal 101. Each of configuration 1 and configuration 2 corresponds to a separate measurement object configuration. Configuration 1 corresponds to a first measurement object identification, and configuration 2 corresponds to a second measurement object identification.

Optionally, the second indication information includes a configuration identifier corresponding to the configuration currently applied by the terminal 101. Each of configuration 1 and configuration 2 corresponds to a separate measurement configuration. Configuration 1 corresponds to a first measurement identification, and configuration 2 corresponds to a second measurement identification.

Optionally, the second indication information includes a reporting configuration identification corresponding to the configuration currently applied by the terminal 101. Each of configuration 1 and configuration 2 corresponds to a separate reporting configuration. Configuration 1 corresponds to a first reporting configuration identification, and configuration 2 corresponds to a second reporting configuration identification.

It needs to be noted that the embodiments of the present disclosure are described by only taking configuration 1 and configuration 2 as an example. In another embodiment, the configuration is not limited to configuration 1 and configuration 2, but may also include configuration 3, configuration 4 to configuration n, where n is an integer, which is not limited in the embodiments of the present disclosure.

In some embodiments, the first information includes third indication information, and the third indication information indicates whether a current configuration of the terminal 101 is a default configuration.

Optionally, if the third indication information is 1, it indicates that the current configuration of the terminal 101 is a default configuration; and if the third indication information is 0, it indicates that the current configuration of the terminal 101 is a non-default configuration. Or, if the third indication information is 0, it indicates that the current configuration of the terminal 101 is a default configuration; and if the third indication information is 1, it indicates that the current configuration of the terminal 101 is a non-default configuration.

It needs to be noted that the embodiments of the present disclosure are described by taking the first information including the indication information as an example. In another embodiment, the first information directly indicates at least one of: the configuration applied by the terminal 101 or the change occurring in the configuration applied by the terminal 101.

In some embodiments, the first information includes at least one of:
the first information being set to a parameter name corresponding to the configuration currently applied by the terminal 101;
the first information being set to a parameter value corresponding to the configuration currently applied by the terminal 101; or
the first information being set to a configuration identifier corresponding to the configuration currently applied by the terminal 101.

Optionally, a first field of the first information is set to the parameter name corresponding to the configuration currently applied by the terminal 101;
a second field of the first information is set to the parameter value corresponding to the configuration currently applied by the terminal 101; and
a third field of the first information is set to the configuration identifier corresponding to the configuration currently applied by the terminal 101.

In some embodiments, the configuration applied by the terminal 101 is a configuration corresponding to a neighboring cell or a non-serving cell.

In some embodiments, the first information further indicates a corresponding relationship between the configuration corresponding to the neighboring cell or the non-serving cell and a cell identifier of the neighboring cell or the non-serving cell; or, the first information further indicates at least one of: a corresponding relationship between a default configuration and a cell identifier of the neighboring cell or the non-serving cell, or a corresponding relationship between a non-default configuration and the neighboring cell or the non-serving cell.

Optionally, each configuration has a corresponding relationship with the cell identifier of the neighboring cell. For example, configuration 1 corresponds to a neighboring cell A, a neighboring cell B, and a neighboring cell C; configuration 2 corresponds to a neighboring cell D; and configuration 3 corresponds to a neighboring cell E and a neighboring cell F. For another example, the neighboring cell A corresponds to configuration 1, the neighboring cell B corresponds to configuration 2, the neighboring cell C corresponds to configuration 3, and the neighboring cell D corresponds to configuration 2.

Optionally, the default configuration has a corresponding relationship with the cell identifier of the neighboring cell, and the non-default configuration has a corresponding relationship with the neighboring cell. For example, the default configuration corresponds to the neighboring cell A, the neighboring cell B, and the neighboring cell C; and the non-default configuration corresponds to the neighboring cell D. For another example, the neighboring cell A corresponds to the default configuration, the neighboring cell B corresponds to the default configuration, and the neighboring cell C corresponds to the non-default configuration.

In some embodiments, the terminal determines whether the configuration applied by the terminal changes based on whether a height of the terminal changes; or the terminal determines whether the configuration applied by the terminal changes from a first configuration to a second configuration.

Optionally, determining whether the configuration applied by the terminal changes based on whether the height of the terminal changes includes at least one of the followings.
(1) The height of the terminal is above a first threshold.

In the embodiments of the present disclosure, if the height of the terminal is above the first threshold, it indicates that the configuration applied by the terminal changes. For example, if the height of the terminal is above the first threshold, the terminal applies configuration 1; and if the height of the terminal is not above the first threshold, the terminal applies configuration 2.
(2) The height of the terminal is not below the first threshold, the configuration applied by the terminal changes. For example, if the height of the terminal is not below the first threshold, the terminal applies configuration 1; and if the height of the terminal is below the first threshold, the terminal applies configuration 2.
(3) The height of the terminal is below the first threshold, the configuration applied by the terminal changes. For example, if the height of the terminal is below the first threshold, the terminal applies configuration 1; and if the height of the terminal is not below the first threshold, the terminal applies configuration 2.
(4) The height of the terminal is not above the first threshold, the configuration applied by the terminal changes. For example, if the height of the terminal is not above the first threshold, the terminal applies configuration 1; and if the height of the terminal is above the first threshold, the terminal applies configuration 2.
(5) The height of the terminal falls within a first range.

For example, if the height of the terminal falls within the first range, the terminal applies configuration 1; and if the height of the terminal does not fall within the first range, the terminal applies configuration 2.

It needs to be noted that the embodiments of the present disclosure are described by taking “the height of the terminal falls within a first range” as an example. In another embodiment, if the height of the terminal falls within the first range, the terminal applies configuration 1; if the height of the terminal falls within a second range, the terminal applies configuration 2; and if the height of the terminal falls within a third range, the terminal applies configuration 3.
(6) The configuration applied by the terminal changes from a first configuration to a second configuration.

In some embodiments, it is determined whether the configuration applied by the terminal changes, and whether a first message that is sent includes the first information.

In some embodiments, the configuration applied by the terminal changes, the first message includes the first information.

It needs to be noted that the embodiments of the present disclosure are described by taking “the configuration applied by the terminal changes, the first message includes the first information” as an example. In another embodiment, the configuration applied by the terminal does not change, the first message does not include the first information.

In some embodiments, the configuration applied by the terminal does not change, the first message includes the first information.

It needs to be noted that the embodiments of the present disclosure are described by taking “the configuration applied by the terminal does not change, the first message includes the first information” as an example. In another embodiment, the configuration applied by the terminal changes, the first message does not include the first information.

In some embodiments, it is determined whether the configuration applied by the terminal changes, and the value of the first information included in the first message that is sent is determined.

In some embodiments, the configuration applied by the terminal changes, the first information is a first value.

In some embodiments, the configuration applied by the terminal does not change, the first information is a second value.

At S2104, the network device 102 configures a corresponding configuration for the terminal 101 based on the first information.

In the embodiments of the present disclosure, based on the first information, the network device 102 may determine at least one of: the configuration applied by the terminal 101 or the change occurring in the configuration applied by the terminal 101, and further may determine the configuration currently used by the terminal 101 so as to match a measurement result reported by the network device 102 and a relevant configuration.

In some embodiments, the configuration applied by the terminal 101 is a measurement configuration, that is to say, the configuration applied by the terminal 101 in the embodiments of the present disclosure may be replaced with the measurement configuration, i.e., the measurement configuration applied by the terminal 101, which is not limited in the present disclosure.

It needs to be noted that S2104 in the embodiments of the present disclosure is an optional step, and the embodiments of the present disclosure may also not perform S2104.

The communication method in the embodiments of the present disclosure may include at least one of S2101 to S2104. S2101, S2102, S2103, S2104, and S2105 are optional steps. For example, S2101 may be performed as an independent embodiment; S2102 may be performed as an independent embodiment; S2103 may be performed as an independent embodiment; S2104 may be performed as an independent embodiment; S2101 and S2102 may be performed as an independent embodiment; S2101 and S2103 may be performed as an independent embodiment; S2101 and S2104 may be performed as an independent embodiment; S2102 and S2103 may be performed as an independent embodiment; S2102 and S2104 may be performed as an independent embodiment; S2103 and S2104 may be performed as an independent embodiment; S2101, S2102, and S2103 may be performed as an independent embodiment; S2101, S2102, and S2104 may be performed as an independent embodiment; S2101, S2103, and S2104 may be performed as an independent embodiment; and S2102, S2103, and S2104 may be performed as an independent embodiment, which is not limited thereto.

In some embodiments, S2101 and S2103 may be exchanged in order or performed simultaneously, and S2102 and S2104 may be exchanged in order or performed simultaneously.

In some embodiments, S2101, S2102, and S2104 are optional steps, and one or more of the steps may be omitted or substituted in different embodiments.

In some embodiments, S2101, S2103, and S2104 are optional steps, and one or more of the steps may be omitted or substituted in different embodiments.

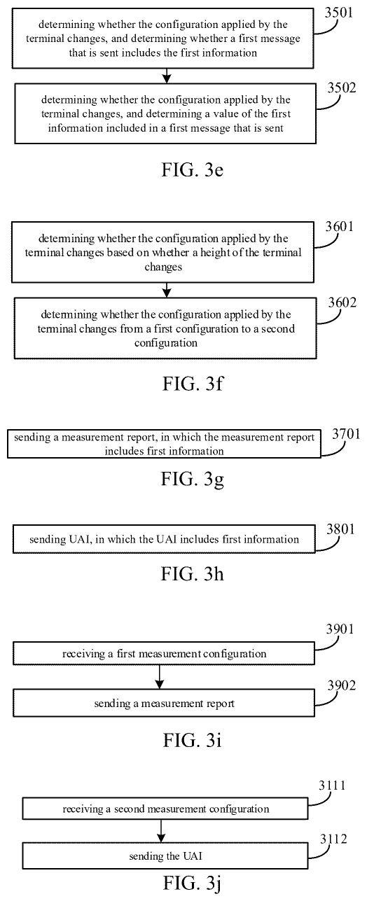

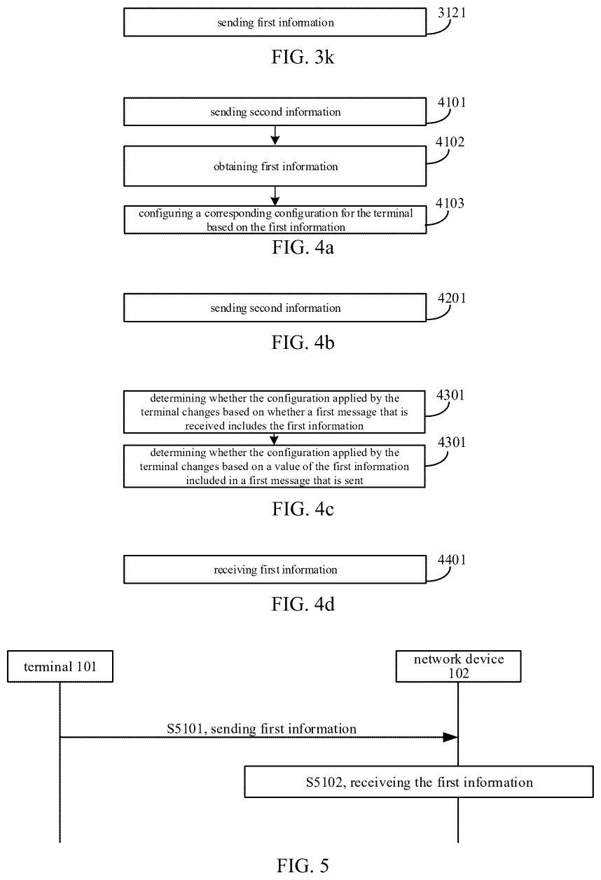

FIG. 3a is a flowchart of a communication method according to an embodiment of the present disclosure. As shown in FIG. 3a, the embodiment of the present disclosure relates to a communication method, which is performed by the terminal 101. The method includes the following steps.

At S3101, second information is obtained.

Regarding optional implementations of S3101, reference may be made to the optional implementations of S2101 in FIG. 2 and other related parts in the embodiments in FIG. 2, which will not be repeated here.

In some embodiments, the terminal 101 receives the second information sent by the network device 102, which is not limited thereto, and the terminal 101 may also receive the second information sent by other entities.

In some embodiments, the terminal 101 obtains the second information specified by a protocol.

In some embodiments, the terminal 101 obtains the second information from an upper layer(s).

In some embodiments, the terminal 101 performs processing to obtain the second information.

In some embodiments, S3101 is omitted, and the terminal 101 autonomously performs a function indicated by the second information, or the above function is a default or preset function.

At S3102, at least one of: a configuration currently applied or whether the configuration currently applied changes is determined.

Regarding optional implementations of S3102, reference may be made to the optional implementations of S2102 in FIG. 2, which will not be repeated here.

At S3103, first information is sent.

Regarding optional implementations of S3103, reference may be made to the optional implementations of S2103 in FIG. 2 and other related parts in the embodiments involved in FIG. 2, which will not be repeated here.

In some embodiments, the first information is carried in a first message.

In some embodiments, the terminal 101 sends the first information to the access network device 102, which is not limited to thereto, and the terminal 101 may also send the first information to other entities.

Optionally, the above first information is used for the access network device 102 to configure a corresponding configuration for the terminal 101. Regarding its optional implementations, reference may be made to the optional implementations of S2104 in FIG. 2 and other related parts in the embodiments in FIG. 2, which will not be repeated here.

The communication method in the embodiments of the present disclosure may include at least one of S3101 to S3103. For example, S3101 may be performed as an independent embodiment; S3102 may be performed as an independent embodiment; S3103 may be performed as an independent embodiment; S3101 and S3102 may be performed as an independent embodiment; S3101 and S3103 may be performed as an independent embodiment; S3102 and S3103 may be performed as an independent embodiment, which it is not limited to this.

In some embodiments, S3101 and S3102 may be exchanged in order or performed simultaneously.

In some embodiments, S3101 and S3102 are optional steps, and one or more of the steps may be omitted or substituted in different embodiments.

In some embodiments, S3102 and S3103 (all steps except the step where the inventive point 2 is located) are optional steps, and one or more of the steps may be omitted or substituted in different embodiments.

FIG. 3b is a flowchart of a communication method according to an embodiment of the present disclosure. As shown in FIG. 3b, the embodiment of the present disclosure relates to a communication method, which is performed by a terminal 101. The method includes the following step.

At S3201, the configuration applied by the terminal changes, first information is sent.

In some embodiments, the first information is included in a first message.

In some embodiments, the configuration applied by the terminal changing means that a configuration applied by the terminal last time is different from a configuration currently applied by the terminal.

In some embodiments, the first message includes a configuration corresponding to a neighboring cell.

In some embodiments, the first message is a measurement report. That is to say, the present disclosure reports the configuration corresponding to the neighboring cell via the measurement report. In some embodiments, the first message is UAI.

FIG. 3c is a flowchart of a communication method according to an embodiment of the present disclosure. As shown in FIG. 3c, the embodiment of the present disclosure relates to a communication method, which is performed by the terminal 101. The method includes the following step.

At S3301, reporting of a measurement report is triggered, first information is sent.

Regarding optional implementations of S3301, reference may be made to the optional implementations of S2103 in FIG. 2 or S3103 in FIG. 3a, or the optional implementations of S3201 in FIG. 3b, which will not be repeated here.

Furthermore, regarding a process of triggering reporting of the measurement report in the embodiments of the present disclosure, reference may be made to the description of the measurement reporting in the above embodiments, which will not be repeated here.

FIG. 3d is a flowchart of a communication method according to an embodiment of the present disclosure. As shown in FIG. 3d, the embodiment of the present disclosure relates to a communication method, which is performed by the terminal 101. The method includes the following step.

At S3401, first information is sent in a case that the terminal has not sent the first information.

In some embodiments, the first information is carried in or included in the first message.

In some embodiments, a second message is sent in a case that the terminal has not sent the first information since the terminal is configured to send the first information via the first message.

Regarding optional implementations of S3401, reference may be made to the optional implementations of S2103 in FIG. 2 or S3103 in FIG. 3a, or the optional implementations of S3201 in FIG. 3b, which will not be repeated here.

FIG. 3e is a flowchart of a communication method according to an embodiment of the present disclosure. As shown in FIG. 3e, the embodiment of the present disclosure relates to a communication method, which is performed by a terminal 101. The method includes the following steps.

At S3501, it is determined whether the configuration applied by the terminal changes, and it is determined whether a first message that is sent includes the first information.

In some embodiments, the configuration applied by the terminal changes, the first message includes the first information.

It needs to be noted that the embodiments of the present disclosure are described by taking “the configuration applied by the terminal changes, the first message includes the first information” as an example. In another embodiment, the configuration applied by the terminal does not change, the first message does not include the first information.

In some embodiments, the configuration applied by the terminal does not change, the first message includes the first information.

It needs to be noted that the embodiments of the present disclosure are described by taking “the configuration applied by the terminal does not change, the first message includes the first information” as an example. In another embodiment, the configuration applied by the terminal changes, the first message does not include the first information.

At S3502, it is determined whether the configuration applied by the terminal changes, and a value of the first information included in a first message that is sent is determined.

In some embodiments, the configuration applied by the terminal changes, the first information is a first value.

In some embodiments, the configuration applied by the terminal does not change, the first information is a second value.

It needs to be noted that S3301 and S3302 may each form an independent embodiment, or, S3301 and S3302 may be performed simultaneously, which is not limited in the embodiments of the present disclosure.

FIG. 3f is a flowchart of a communication method according to an embodiment of the present disclosure. As shown in FIG. 3f, the embodiment of the present disclosure relates to a communication method, which is performed by the terminal 101. The method includes the following steps.

At S3601, it is determined whether the configuration applied by the terminal changes based on whether a height of the terminal changes.

At S3602, it is determined whether the configuration applied by the terminal changes from a first configuration to a second configuration.

In some embodiments, determining whether the configuration applied by the terminal changes based on whether the height of the terminal changes includes at least one of the followings.
(1) The height of the terminal is above a first threshold.

In the embodiments of the present disclosure, if the height of the terminal is above the first threshold, it indicates that the configuration applied by the terminal changes. For example, if the height of the terminal is above the first threshold, the terminal applies configuration 1; and if the height of the terminal is not above the first threshold, the terminal applies configuration 2.
(2) The height of the terminal is not below the first threshold, the configuration applied by the terminal changes. For example, if the height of the terminal is not below the first threshold, the terminal applies configuration 1; and if the height of the terminal is below the first threshold, the terminal applies configuration 2.
(3) The height of the terminal is below the first threshold, the configuration applied by the terminal changes. For example, if the height of the terminal is below the first threshold, the terminal applies configuration 1; and if the height of the terminal is not below the first threshold, the terminal applies configuration 2.
(4) The height of the terminal is not above the first threshold, the configuration applied by the terminal changes. For example, if the height of the terminal is not above the first threshold, the terminal applies configuration 1; and if the height of the terminal is above the first threshold, the terminal applies configuration 2.
(5) The height of the terminal falls within a first range.

For example, the height of the terminal falls within the first range, the terminal applies configuration 1; and the height of the terminal does not fall within the first range, the terminal applies configuration 2.

It needs to be noted that the embodiments of the present disclosure are described by taking “the height of the terminal falls within the first range” as an example. In another embodiment, the height of the terminal falls within the first range, the terminal applies configuration 1; the height of the terminal falls within a second range, the terminal applies configuration 2; and the height of the terminal falls within a third range, the terminal applies configuration 3.
(6) The configuration applied by the terminal changes from a first configuration to a second configuration.

FIG. 3g is a flowchart of a communication method according to an embodiment of the present disclosure. As shown in FIG. 3g, the embodiment of the present disclosure relates to a communication method, which is performed by the terminal 101. The method includes the following step.

At S3701, a measurement report is sent, in which the measurement report includes first information.

In some embodiments, the first information indicates at least one of: a configuration applied by the terminal or a change occurring in the configuration applied by the terminal.

In some embodiments, the terminal sends the measurement report to the network device. In some embodiments, the terminal sends the measurement report to another entity.

In an embodiment, the terminal receives measurement configuration information sent by the network device, determines the configuration that is applied based on the measurement configuration information of the network device and its own height, and triggers measurement and measurement reporting based on the configuration. In response to the change occurring in the configuration applied by the terminal, the terminal triggers the measurement report once, and the measurement report includes the first information.

In an embodiment, the terminal receives the measurement configuration information sent by the network device, determines the configuration that is applied based on the measurement configuration information of the network device and its own height, and triggers measurement and measurement reporting based on the configuration. Each measurement report includes the first information.

FIG. 3h is a flowchart of a communication method according to an embodiment of the present disclosure. As shown in FIG. 3h, the embodiment of the present disclosure relates to a communication method, which is performed by a terminal 101. The method includes the following step.

At S3801, UAI is sent, in which the UAI includes first information.

In some embodiments, the first information indicates at least one of: a configuration applied by the terminal or a change occurring in the configuration applied by the terminal.

In some embodiments, the terminal sends the UAI to the network device. In some embodiments, the terminal sends the UAI to another entity.

In an embodiment, if the terminal is configured to report the first information, and if the terminal has not sent the UAI including the first information since the terminal is configured to report the first information, the terminal initiates a UAI sending procedure to provide the first information to the network device. The UAI includes the first information, and then the UAI is sent.

In an embodiment, if the terminal is configured to report the first information, if the configuration currently applied by the terminal is not a default configuration, and the terminal has not sent the UAI including the first information since the terminal is configured to report the first information, the terminal initiates a UAI sending procedure to provide the first information to the network device. The UAI includes the first information, and then the UAI is sent.

In an embodiment, if the terminal is configured to report the first information via the UAI, and if the configuration currently applied by the terminal is different from the configuration applied by the terminal that is last reported, the terminal initiates a UAI sending procedure to provide the first information to the network device. The UAI includes the first information, and then the UAI is sent.

In an embodiment, if the terminal is configured to report the first information via the UAI, and if the configuration currently applied by the terminal does not match the configuration applied by the terminal that is last reported, the terminal initiates a UAI sending procedure to provide the first information to the network device. The UAI includes the first information, and then the UAI is sent.

FIG. 3i is a flowchart of a communication method according to an embodiment of the present disclosure. As shown in FIG. 3i, the embodiment of the present disclosure relates to a communication method, which is performed by the terminal 101. The method includes the following steps.

At S3901, a first measurement configuration is received, in which the first measurement configuration is used to configure that the terminal sends first information via a measurement report.

In some embodiments, the first information indicates at least one of: a configuration applied by the terminal or a change occurring in the configuration applied by the terminal.

In an embodiment, based on indication information of the applied configuration included in a measurement configuration sent by the network device, whether the terminal needs to report the first information is indicated.

The indication information of the applied configuration indicates that the terminal needs to send the first information.

The network device may carry a reporting configuration indicated by the applied configuration (or a reporting configuration indicated by the applied configuration is configured to be a specific value) in a corresponding measurement configuration (for example, a measurement object configuration, a measurement identification configuration, a reporting configuration), which configures that the first information of the terminal is sent via measurement reporting.

At S3902, a measurement report is sent.

In some embodiments, the measurement report includes the first information.

In some embodiments, the first information indicates at least one of: a configuration applied by the terminal or a change occurring in the configuration applied by the terminal.

In some embodiments, the terminal sends the measurement report to the network device. In some embodiments, the terminal sends the measurement report to another entity.

FIG. 3j is a flowchart of a communication method according to an embodiment of the present disclosure. As shown in FIG. 3j, the embodiment of the present disclosure relates to a communication method, which is performed by the terminal 101. The method includes the following steps.

At S3111, a second measurement configuration is received, in which the second measurement configuration is used to configure that the terminal sends first information via UAI.

In some embodiments, the first information indicates at least one of: a configuration applied by the terminal or a change occurring in the configuration applied by the terminal.

In an embodiment, the network device may configure, via an RRC message (e.g., an RRCReconfiguration message), that the terminal sends the first information via the UAI.

For example, it is configured in OtherConfig information. The OtherConfig includes indication information of the applied configuration of a SetupRelease category. In response to the UE receiving the OtherConfig, if the OtherConfig includes a reporting configuration indicated by the applied configuration, if the configuration is set to be “setup”, it is considered that the UE is configured to report the first information; if the configuration is not set to be “setup” (e.g., set to be “release”), it is considered that the UE is not configured to report the first information.

At S3112, the UAI is sent, in which the UAI includes the first information.

In some embodiments, the first information indicates at least one of: a configuration applied by the terminal or a change occurring in the configuration applied by the terminal.

In some embodiments, the terminal sends the UAI to the network device. In some embodiments, the terminal sends the UAI to another entity.

FIG. 3k is a flowchart of a communication method according to an embodiment of the present disclosure. As shown in FIG. 3k, the embodiment of the present disclosure relates to a communication method, which is performed by the terminal 101. The method includes the following step.

At S3121, first information is sent.

In an optional embodiment, S3121 further includes optional steps S3201, S3301, S3401, S3501, S3601, S3602, S3701, S3801, S3901, S3902, S3111, and S3112.

For optional implementations of the optional step S3121, reference may be made to S2103 in FIG. 2, S3103 in FIG. 3a, S3201 in FIG. 3b, optional implementations of S3201, S3301 in FIG. 3c, optional implementations of S3301, S3401 in FIG. 3d, optional implementations of S3401, S3501 in FIG. 3e, optional implementations of S3501, S3601, S3602 in FIG. 3f, optional implementations of S3601, S3602, S3701 in FIG. 3g, optional implementations of S3701, S3801 in FIG. 3h, optional implementations of S3801, S3901 in FIG. 3i, optional implementations of S3901, S3111 in FIG. 3j, optional implementations of S3112, and other related parts in the embodiments of FIG. 2, FIG. 3a, FIG. 3b, FIG. 3c, FIG. 3d, FIG. 3e, FIG. 3f, FIG. 3g, FIG. 3h, FIG. 3i, and FIG. 3j, which will not be repeated here.

In some embodiments, sending the first information includes at least one of:
sending the first information in a case that the configuration applied by the terminal changes; or
sending the first information in a case that the terminal has not sent the first information.

In some embodiments, sending the first information in a case that the terminal has not sent the first information includes:
sending the first information in a case that the terminal has not sent the first information since the terminal is configured to send the first information via a first message.

In some embodiments, the method further includes:
receiving second information, in which the second information is used to configure whether the terminal indicates, via the first information, at least one of: the configuration applied by the terminal or the change occurring in the configuration applied by the terminal.

In some embodiments, the first information is included in a first message.

In some embodiments, the first message is a measurement report or the first message is UAI.

In some embodiments, the method further includes at least one of:
determining whether the configuration applied by the terminal changes, and determining whether a first message that is sent includes the first information; or
determining whether the configuration applied by the terminal changes, and determining a value of the first information included in a first message that is sent.

In some embodiments, determining whether the configuration applied by the terminal changes, and determining whether the first message that is sent includes the first information includes:
determining that the configuration applied by the terminal changes and the first message includes the first information;
or,
determining that the configuration applied by the terminal does not change and the first message includes the first information.

In some embodiments, determining whether the configuration applied by the terminal changes, and determining the value of the first information included in the first message that is sent includes at least one of:
determining that the configuration applied by the terminal changes and the first information is a first value; or
determining that the configuration applied by the terminal does not change and the first information is a second value.

In some embodiments, the first information includes at least one of:
the first information being set to a parameter name corresponding to a configuration currently applied by the terminal;
the first information being set to a parameter value corresponding to a configuration currently applied by the terminal; or
the first information being set to a configuration identifier corresponding to a configuration currently applied by the terminal.

In some embodiments, the configuration applied by the terminal is a configuration corresponding to a neighboring cell or a non-serving cell.

In some embodiments, the first information further indicates a corresponding relationship between the configuration corresponding to the neighboring cell or the non-serving cell and a cell identifier of the neighboring cell or the non-serving cell;
or,
the first information further indicates at least one of: a corresponding relationship between a default configuration and a cell identifier of the neighboring cell or the non-serving cell, or a corresponding relationship between a non-default configuration and the neighboring cell or the non-serving cell.

In some embodiments, determining whether the configuration applied by the terminal changes includes at least one of:
determining whether the configuration applied by the terminal changes based on whether a height of the terminal changes; or
determining whether the configuration applied by the terminal changes from a first configuration to a second configuration.

In some embodiments, the height includes at least one of:
the height of the terminal being above a first threshold;
the height of the terminal not being above the first threshold;
the height of the terminal being below the first threshold;
the height of the terminal not being below the first threshold;
the height of the terminal falling within a first range; or
the height of the terminal not falling within the first range.

In some embodiments, the configuration applied by the terminal is a measurement configuration.

FIG. 4a is a flowchart of a communication method according to an embodiment of the present disclosure. As shown in FIG. 4a, the embodiment of the present disclosure relates to a communication method, which is performed by the network device 102. The method includes the following steps.

At S4101, second information is sent.

Regarding optional implementations of S4101, reference may be made to the optional implementations of S2101 in FIG. 2, which will not be repeated here.

In some embodiments, the access network device 102 sends the second information to the terminal 101, which is not limited thereto, and the access network device 102 may also send the second information to other entities.

Optionally, the above second information is used to configure that the terminal 101 performs the step of sending the first information. For optional implementations, reference may be made to the optional implementations of S2101 in FIG. 2 and other related parts in the embodiments in FIG. 2, which will not be repeated here.

At S4102, first information is obtained.

Regarding optional implementations of S4102, reference may be made to the optional implementations of S2103 in FIG. 2, which will not be repeated here.

In some embodiments, the network device receives the first information. In other embodiments, the network device receives the first information sent by the terminal. In other embodiments, the network device may also receive the first information sent by other entities.

In some embodiments, the network device 102 receives the first information sent by the terminal 101, which is not limited thereto, and the network device 102 may also receive the first information sent by other entities.

In some embodiments, the network device 102 obtains the first information specified by a protocol.

In some embodiments, the network device 102 obtains the first information from an upper layer(s).

In some embodiments, the network device 102 performs processing to obtain the first information.

In some embodiments, S4102 is omitted, and the network device 102 autonomously implements a function indicated by the first information, or the above function is a default or preset function.

At S4103, a corresponding configuration is configured for the terminal based on the first information.

Regarding optional implementations of S4103, reference may be made to the optional implementations of S2105 in FIG. 2, which will not be repeated here.

The communication method in the embodiments of the present disclosure may include at least one of S4101 to S4103. For example, S4101 may be performed as an independent embodiment; S4102 may be performed as an independent embodiment; S4103 may be performed as an independent embodiment; S4101 and S4102 may be performed as an independent embodiment; S4101 and S4103 may be performed as an independent embodiment; and S4102 and S4103 may be performed as an independent embodiment, which is not limited to these.

In some embodiments, S4101 and S4102 may be exchanged in order or performed simultaneously.

In some embodiments, S4101 and S4103 are optional steps, and one or more of the steps may be omitted or substituted in different embodiments.

In some embodiments, S4102 and S4103 (all steps except the step where the inventive point 2 is located) are optional steps, and one or more of the steps may be omitted or substituted in different embodiments.

In the embodiments of the present disclosure, for some or all steps, their optional implementations may be arbitrarily combined with some or all steps in other embodiments, and may also be arbitrarily combined with optional implementations of other embodiments.

FIG. 4b is a flowchart of a communication method according to an embodiment of the present disclosure. As shown in FIG. 4b, the embodiment of the present disclosure relates to a communication method, which is performed by the network device 102. The method includes the following step.

At S4201, second information is sent.

Regarding optional implementations of S4201, reference may be made to the optional implementations of S2101 in FIG. 2, which will not be repeated here.

FIG. 4c is a flowchart of a communication method according to an embodiment of the present disclosure. As shown in FIG. 4c, the embodiment of the present disclosure relates to a communication method, which is performed by the network device 102. The method includes the following steps.

At S4301, it is determined whether the configuration applied by the terminal changes based on whether a first message that is received includes the first information.

In some embodiments, the first message includes the first information, it is determined that the configuration applied by the terminal changes.

In some embodiments, the first message includes the first information, it is determined that the configuration applied by the terminal does not change.

At S4302, it is determined whether the configuration applied by the terminal changes based on a value of the first information included in a received first message.

In some embodiments, determining whether the configuration applied by the terminal changes based on the value of the first information included in the received first message includes at least one of:
determining that the configuration applied by the terminal changes based on the first information being a first value; or
determining that the configuration applied by the terminal does not change based on the first information being a second value.

Regarding optional implementations of S4301 and S4302, reference may be made to the optional implementations of S2101 in FIG. 2, S3501 and S3502 in FIG. 3e, which will not be repeated here.

It needs to be noted that S4301 and S4302 in the embodiments of the present disclosure may form an independent embodiment, or S4301 and S4302 may be executed simultaneously, which is not limited in the embodiments of the present disclosure.

FIG. 4d is a flowchart of a method for reporting a measurement according to an embodiment of the present disclosure. As shown in FIG. 4d, the embodiment of the present disclosure relates to a communication method, which is performed by the network device 102. The method includes the following step.

At S4401, first information is received.

In some embodiments, the first information indicates at least one of: a configuration applied by the terminal or a change occurring in the configuration applied by the terminal.

Regarding optional implementations of S4401, reference may be made to the optional implementations of S2103 in FIG. 2, which will not be repeated here.

In some embodiments, the first information is sent in a case that the configuration applied by the terminal changes;
or,
the first information is sent in a case that the terminal has not sent the first information.

In some embodiments, the first information is sent in a case that the terminal has not sent the first information since the terminal is configured to send the first information via a first message.

In some embodiments, the method further includes:
sending second information, in which the second information is used to configure whether the terminal indicates, via the first information, at least one of: the configuration applied by the terminal or the change occurring in the configuration applied by the terminal.

In some embodiments, the first information is included in a first message.

In some embodiments, the first message is a measurement report or the first message is UAI.

In combination with some embodiments of the second aspect, in some embodiments, the method further includes at least one of:
determining whether the configuration applied by the terminal changes based on whether a received first message includes the first information; or
determining whether the configuration applied by the terminal changes based on a value of the first information included in a received first message.

In some embodiments, determining whether the configuration applied by the terminal changes based on whether the received first message includes the first information includes:
determining that the configuration applied by the terminal changes based on the first message including the first information;
or,
determining that the configuration applied by the terminal does not change based on the first message including the first information.

In some embodiments, determining whether the configuration applied by the terminal changes based on the value of the first information included in the received first message includes at least one of:
determining that the configuration applied by the terminal changes based on the first information being a first value; or
determining that the configuration applied by the terminal does not change based on the first information being a second value.

In some embodiments, the first information includes at least one of:
the first information being set to a parameter name corresponding to a configuration currently applied by the terminal;
the first information being set to a parameter value corresponding to a configuration currently applied by the terminal; or
the first information being set to a configuration identifier corresponding to a configuration currently applied by the terminal.

In some embodiments, the configuration applied by the terminal is a configuration corresponding to a neighboring cell or a non-serving cell.

In some embodiments, the first information further indicates a corresponding relationship between the configuration corresponding to the neighboring cell or the non-serving cell and a cell identifier of the neighboring cell or the non-serving cell;
or,
the first information further indicates at least one of: a corresponding relationship between a default configuration and a cell identifier of the neighboring cell or the non-serving cell, or a corresponding relationship between a non-default configuration and the neighboring cell or the non-serving cell.

In some embodiments, determining whether the configuration applied by the terminal changes includes at least one of:
determining, by the terminal, whether the configuration applied by the terminal changes based on whether a height of the terminal changes; or
determining whether the configuration applied by the terminal changes from a first configuration to a second configuration.

In some embodiments, the height includes at least one of:
the height of the terminal being above a first threshold;
the height of the terminal not being above the first threshold;
the height of the terminal being below the first threshold;
the height of the terminal not being below the first threshold;
the height of the terminal falling within a first range; or
the height of the terminal not falling within the first range.

In some embodiments, the configuration applied by the terminal is a measurement configuration.

FIG. 5 is a flowchart of a communication method according to an embodiment of the present disclosure. As shown in FIG. 5, the embodiment of the present disclosure relates to a communication method, which is performed by a communication system 100. The method includes the following steps.

At S5101, the terminal 101 sends first information to the network device 102.

In some embodiments, the first information indicates at least one of: a configuration applied by the terminal 101 or a change occurring in the configuration applied by the terminal 101.

At S5102, the network device 102 receives the first information sent by the terminal 101.

In some embodiments, the first information indicates at least one of: a configuration applied by the terminal 101 or a change occurring in the configuration applied by the terminal 101.

Regarding optional implementations of S5101, reference may be made to the optional implementations of S2103 in FIG. 2, S3103, S3201, S3301, S3401, S3501, and S3601 in FIGS. 3a-3k, and other related parts in the embodiments of FIG. 2 and FIGS. 3a-3k, which will not be repeated here.

In some embodiments, the above method may include methods of embodiments on the communication system side, terminal 101 side, network device 102 side, etc., which will not be repeated here.

It needs to be noted that the above embodiments may be split into new embodiments or combined with other embodiments to form new embodiments. The present disclosure does not pose a limitation to a combination of embodiments.

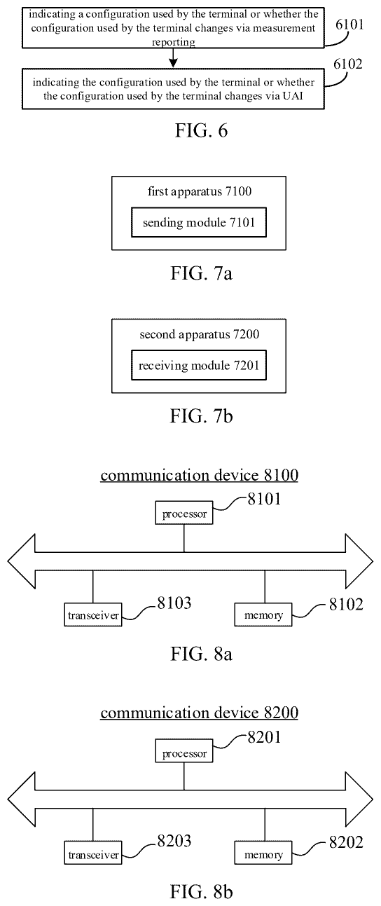

FIG. 6 is a schematic diagram of a communication method according to an embodiment of the present disclosure. As shown in FIG. 6, the embodiment of the present disclosure relates to a communication method. The method includes the following steps.

At S6101, a configuration used by the terminal or whether the configuration used by the terminal changes is indicated via measurement reporting.

In a possible implementation, in response to the change of the configuration used by the terminal, the terminal triggers the measurement reporting, in which a measurement report indicates the configuration used by the terminal or the change occurring in the configuration used by the terminal.

Optionally, the change occurring in the configuration used by the terminal means that the terminal autonomously changes the configuration used by the terminal based on a height.

In another possible implementation, the terminal triggers the measurement reporting based on a configuration that is currently used, and indicates the configuration used by the terminal or whether the configuration used by the terminal changes in the corresponding measurement report.

Optionally, a configuration corresponding to a neighboring cell (or non-serving cell) that is reported is indicated in the measurement report.

It needs to be noted that the network device instructs the terminal to report via the configuration. In a possible implementation, based on a configuration from the network side, it is determined whether information related to the configuration used by the terminal needs to be included in the measurement report.

At S6102, the configuration used by the terminal or whether the configuration used by the terminal changes is indicated via UAI.

In a possible implementation, if the terminal has not reported the configuration used by the terminal or whether the configuration used by the terminal changes since the terminal is configured to report the information related to the configuration used by the terminal via the UAI, UAI reporting is triggered, and the UAI indicates the configuration used by the terminal or whether the configuration used by the terminal changes.

In another possible implementation, in response to the change in the configuration used by the terminal, the UAI reporting is triggered, and the UAI indicates the configuration used by the terminal or the change occurring in the configuration used by the terminal.

It needs to be noted that the network device instructs the terminal to report via the configuration. In a possible implementation, based on a configuration from the network side, it is determined whether the information related to the configuration used by the terminal needs to be reported via the UAI.

S6101 and S6102 are parallel solutions. The terminal may perform S6101 or S6102, which is not limited in the embodiments of the present disclosure.

Specific explanations for terms in the present disclosure are provided below.

In some embodiments, a specific explanation of “a change occurring in the configuration used by the terminal” will be described as follows.

The change occurring in the configuration used by the terminal below means that the terminal autonomously changes the configuration used by the terminal (or the configuration that is applied) based on the height.

For example, when the height of the terminal is greater than (greater than or equal to/less than/less than or equal to) a threshold value, configuration 1 is applied; otherwise, configuration 2 is applied; or, when the height of the terminal belongs to range 1 (or satisfies condition 1), the terminal applies configuration 1; otherwise, the terminal applies configuration 2; or, when the height of the terminal belongs to range 1 (or satisfies condition 1), the terminal applies configuration 1; when the height of the terminal belongs to range 2 (or satisfies condition 2), the terminal applies configuration 2; and when the height of the terminal belongs to range 3 (or satisfies condition 3), the terminal applies configuration 3.

The change occurring in the configuration used by the terminal below means that the configuration of the terminal changes from configuration 1 to configuration 2, or from configuration 2 to configuration 1, or from configuration 2 to configuration 3, etc.

The configuration used by the terminal may be a measurement configuration used by the terminal, for example, measurement-related configuration information such as a measurement object configuration, a measurement identification, a measurement reporting configuration, etc. Different configurations may correspond to different measurement object configurations, measurement identifications, measurement reporting configurations, etc. Different configurations may also correspond to different parameters, or different parameter values.

In some embodiments, a specific explanation of “determining whether the configuration used by the terminal changes” will be described as follows.

The terminal may indicate whether the used configuration changes via indication information. The indication information may be included in first information or a first message (for example, a measurement report, UAI, etc.).

Optionally, if the first information or the first message includes the indication information, it indicates that the terminal changes the used configuration; otherwise, the terminal does not change the used configuration.

Optionally, if the first information or the first message includes the indication information, it indicates that the terminal does not change the used configuration; otherwise, the terminal changes the used configuration.

Optionally, if the first information or the first message includes the indication information and the indication information is a specific value, it indicates that the terminal changes the used configuration; otherwise, the terminal does not change the used configuration.

Optionally, if the first information or the first message includes the indication information and the indication information is a specific value, it indicates that the terminal does not change the used configuration; otherwise, the terminal changes the used configuration.

Optionally, if the first information or the first message includes the indication information and the indication information is a specific value A, it indicates that the terminal changes the used configuration; if the indication information is a specific value B, it indicates that the terminal does not change the used configuration.

In some embodiments, a specific explanation of “indicating a configuration used by the terminal” will be described as follows.

The terminal may indicate the used configuration via the indication information. The indication information may be included in first information or a first message (for example, a measurement report, UAI, etc.).

The first information or the first message includes the indication information, which is a configuration currently used by the terminal.

Optionally, the indication information indicates a parameter name corresponding to the configuration used by the terminal.

For example, the indication information in configuration 1 corresponds to parameter A, and the indication information in configuration 2 corresponds to parameter B.

Optionally, the indication information indicates a specific parameter value corresponding to the configuration used by the terminal.

For example, the indication information in configuration 1 corresponds to a first value a of parameter A, and the indication information in configuration 2 corresponds to a second value b of parameter A.

Optionally, the indication information indicates an identifier corresponding to the configuration used by the terminal.

For example, each of configuration 1 and configuration 2 corresponds to an independent measurement object configuration. Configuration 1 corresponds to a first measurement object identification, and configuration 2 corresponds to a second measurement object identification.

In some embodiments, a specific explanation of “based on the configuration from the network side” will be described as follows.

The configuration from the network side means that, based on indication information of the applied configuration sent by the network side, it is indicated whether the terminal needs to report the information related to the configuration used by the terminal, in which the information related to the configuration used by the terminal may be the configuration used by the terminal, whether the configuration used by the terminal changes, etc.

The network side may carry a reporting configuration indicated by the applied configuration (or a reporting configuration indicated by the applied configuration is configured to be a specific value) in a corresponding measurement configuration (for example, a measurement object configuration, a measurement identification configuration, a reporting configuration), which configures that the information related to the configuration used by the terminal is sent via the measurement reporting.

In an embodiment, the terminal receives measurement configuration information sent by the network side, determines the configuration to be applied based on the configuration information from the network side and its own height, and triggers measurement and measurement reporting based on this configuration. In response to a change occurring in the configuration applied by the terminal, the terminal triggers the measurement reporting once, carrying information related to the configuration used by the terminal.

In an embodiment, the terminal receives the measurement configuration information sent by the network side, determines the configuration to be applied based on the configuration information from the network side and its own height, and triggers measurement and measurement reporting based on the configuration. Each measurement report carries the information related to the configuration used by the terminal when triggering the measurement reporting.

The network side may configure, via an RRC message (e.g., RRCReconfiguration message), that the information related to the configuration used by the terminal is sent via the UAI. For example, it is configured in OtherConfig information. The OtherConfig includes indication information of the applied configuration of a SetupRelease category. In response to the UE receiving the OtherConfig, if the OtherConfig includes a reporting configuration indicated by the applied configuration, if the configuration is set to be “setup”, it is considered that the UE is configured to report the information related to the configuration used by the terminal; if the configuration is not set to be “setup” (e.g., set to be “release”), it is considered that the UE is not configured to report the information related to the configuration used by the terminal.

In an embodiment, if the terminal is configured to report the information related to the configuration used by the terminal, and if the terminal has not sent the UAI including the information related to the configuration used by the terminal since the terminal is configured to report the information related to the configuration used by the terminal, the terminal initiates a UAI sending procedure to provide the network with the information related to the configuration used by the terminal. The UAI includes the configuration currently applied by the terminal, or indicates whether the configuration currently applied by the terminal is a default configuration (e.g., the protocol specifies configuration 1 as the default configuration), and then the UAI is sent.

In an embodiment, if the terminal is configured to report the information related to the configuration used by the terminal, and if the configuration currently applied by the terminal is not the default configuration, and the terminal has not sent the UAI including the information related to the configuration used by the terminal since the terminal is configured to report the information related to the configuration used by the terminal, the terminal initiates the UAI sending procedure to provide the network with the information related to the configuration used by the terminal. The UAI includes the configuration currently applied by the terminal, or indicates that the configuration currently applied by the terminal is not the default configuration (e.g., the protocol specifies configuration 1 as the default configuration), and then the UAI is sent.

In an embodiment, if the terminal is configured to report the information related to the configuration used by the terminal via the UAI, and if the configuration currently applied by the terminal is different from the configuration applied by the terminal that is last reported, the terminal initiates the UAI sending procedure to provide the network with the information related to the configuration used by the terminal. The UAI includes the configuration currently applied by the terminal, and then the UAI is sent.

In an embodiment, if the terminal is configured to report the information related to the configuration used by the terminal via the UAI, and if the configuration currently applied by the terminal does not match the configuration applied by the terminal that is last reported (e.g., the current configuration is a default configuration but the configuration that is last reported is a non-default configuration, or vice versa), the terminal initiates the UAI sending procedure to provide the network with the information related to the configuration used by the terminal. The UAI indicates whether the configuration currently applied by the terminal is the default configuration (e.g., the protocol specifies configuration 1 as the default configuration), and then the UAI is sent.

A detailed explanation of “a configuration corresponding to a neighboring cell (or non-serving cell) that is reported is indicated in the measurement report” will be described as follows.

In a process of the measurement reporting, for event-triggered measurement reporting, the terminal needs to perform measurement and event evaluation based on a current measurement configuration. When one or more cells satisfy a measurement event, the terminal adds these cells to a triggering cell list. According to an existing procedure, even if the height of the terminal changes, that is, the configuration applied by the terminal changes, these cells in the triggering cell list will not be removed. However, subsequently, the terminal may perform measurement and event evaluation based on a changed measurement configuration. When another one or more cells satisfy the measurement event, the terminal may add these cells to the triggering cell list. Since the neighboring cells included in the measurement report of the terminal are selected from the triggering cell list, a measurement report corresponding to the measurement reporting may include triggering cells determined based on a measurement configuration before the change and triggering cells determined based on a measurement configuration after the change. However, the network side may not distinguish these cells from the measurement report. Therefore, it is necessary to add, in the measurement report, indication information corresponding to each reported neighboring cell (cells in the triggering cell list). The indication information indicates the configuration used by the terminal corresponding to the neighboring cell. This may be specifically achieved in following ways.

Configuration 1: Neighboring cells A, B, C; Configuration 2: Neighboring cell D; Configuration 3: Neighboring cells E, F.

Neighboring cell A: Configuration 1; Neighboring cell B: Configuration 2; Neighboring cell C: Configuration 3; Neighboring cell D: Configuration 2.

Default configuration: Neighboring cells A, B, C; Non-default configuration: Neighboring cell D.

Neighboring cell A: Default configuration; Neighboring cell B: Default configuration; Neighboring cell C: Non-default configuration.

The embodiments of the present disclosure also provide an apparatus for implementing any one of the above methods. For example, an apparatus is provided, including units for performing steps executed by the terminal in any one of the above methods. Furthermore, another apparatus is provided, including units for performing steps executed by the network device (e.g., an access network device, a core network function node, a core network device, etc.) in any one of the above methods. It should be understood that a division of units in the above apparatus is only a division of logical functions. In actual implementations, they may be fully or partially integrated into one physical entity, or may be physically separated. In addition, the units in the apparatus may be implemented in a form of software invoked by a processor: for example, the apparatus includes a processor, in which the processor is connected to a memory storing instructions. The processor invokes the instructions stored in the memory to implement any one of the above methods or to implement functions of the units of the above apparatus. The processor is, for example, a general-purpose processor, such as a central processing unit (CPU) or a microprocessor, and the memory is a memory inside the apparatus or a memory outside the apparatus. Or, the units in the apparatus may be implemented in a form of a hardware circuit. The functions of some or all units may be implemented by designing the hardware circuit. The hardware circuit may be understood as one or more processors. For example, in an implementation, the hardware circuit is an application specific integrated circuit (ASIC). The functions of some or all units are implemented by designing logical relationships of components within the circuit. In another implementation, the hardware circuit may be implemented by a programmable logic device (PLD). Taking a field-programmable gate array (FPGA) as an example, it may include a large number of logic gate circuits. Connection relationships between the logic gate circuits are configured via configuration files to implement the functions of some or all units. All units of the above apparatus may be fully implemented in a form of software invoked by the processor, or fully implemented in a form of the hardware circuit, or partially implemented in a form of software invoked by the processor and partially implemented in a form of the hardware circuit.

In the embodiments of the present disclosure, the processor is a circuit with a signal processing capability. In an implementation, the processor may be a circuit with a capability to read and run instructions, such as a CPU, a microprocessor, a graphics processing unit (GPU) (which may be understood as a type of the microprocessor), a digital signal processor (DSP), etc. In another implementation, the processor may implement functions via a logical relationship of hardware circuits. The logical relationship of the hardware circuit is fixed or reconfigurable, for example, a hardware circuit implemented by an ASIC or a PLD, such as an FPGA. In a reconfigurable hardware circuit, a process that the processor loads a configuration document to implement a hardware circuit configuration may be understood as a process that the processor loads the instructions to implement the functions of some or all units. Furthermore, it may also be a hardware circuit designed for artificial intelligence, which may be understood as a type of ASIC, such as a neural network processing unit (NPU), a tensor processing unit (TPU), a deep learning processing unit (DPU), etc.

FIG. 7a is a block diagram of a first communication apparatus according to an embodiment of the present disclosure. As shown in FIG. 7a, a first apparatus 7100 includes: a sending module 7101, configured to send first information, in which the first information indicates at least one of: a configuration applied by the terminal or a change occurring in the configuration applied by the terminal. Optionally, the above sending module is configured to perform steps related to sending executed by the terminal 101 in any one of the above methods, which will not be repeated here. Optionally, the first apparatus 7100 further includes a receiving module. The above receiving module is configured to perform steps related to receiving executed by the terminal 101 in any one of the above methods. Optionally, the first apparatus 7100 further includes a processing module. The above processing module is configured to perform steps related to processing executed by the terminal 101 in any one of the above methods, which will not be repeated here.

FIG. 7b is a block diagram of a second communication apparatus according to an embodiment of the present disclosure. As shown in FIG. 7b, a second apparatus 7200 includes: a receiving module 7201, configured to receive first information, in which the first information indicates at least one of: a configuration applied by the terminal or a change occurring in the configuration applied by the terminal. Optionally, the above receiving module is configured to perform steps related to receiving executed by the terminal 101 in any one of the above methods, which will not be repeated here. Optionally, the second apparatus 7200 further includes a sending module. The above sending module is configured to perform steps related to sending executed by the terminal 101 in any one of the above methods. Optionally, the second apparatus 7200 further includes a processing module. The above processing module is configured to perform steps related to processing executed by the terminal 101 in any one of the above methods, which will not be repeated here.

FIG. 8a is a block diagram of a communication device 8100 according to an embodiment of the present disclosure. The communication device 8100 may be a network device (such as an access network device, a core network device, etc.), or a terminal (such as a user equipment, etc.), or a chip, a chip system, a processor, etc. that supports the network device to implement any one of the methods, or a chip, a chip system, a processor, etc. that supports the terminal to implement any one of the methods. The communication device 8100 is configured to implement the method in the above method embodiments. For details, please refer to the description in the above method embodiments.

As shown in FIG. 8a, the communication device 8100 may include one or more processors 8101. The processor 8101 may be a general purpose processor or a special purpose processor, for example, a baseband processor or a central processing unit. The baseband processor may be used to process communication protocols and communication data, and the central processing unit may be used to control communication apparatuses (such as a base station, a baseband chip, a terminal, a terminal chip, a DU or a CU, etc.), execute computer programs, and process computer program data. The processor 8101 is configured to invoke instructions so that the communication device 8100 may implement any one of the above methods.

Optionally, the communication device 8100 may also include one or more memories 8102 for storing instructions. Optionally, all or some of the memories 8102 may also be located outside the communication device 8100.

In some embodiments, the communication device 8100 further includes one or more transceivers 8103. When the communication device 8100 includes one or more transceivers 8103, communication steps such as sending and receiving in the above methods are performed by the transceiver 8103, and other steps are performed by the processor 8101.

In some embodiments, the transceiver may include a receiver and a transmitter, which may be separate or integrated together. Optionally, terms such as transceiver, transceiver unit, transceiving circuit, etc. may be used interchangeably; terms such as transmitter, transmission unit, transmitting circuit, etc. may be used interchangeably; and terms such as receiver, reception unit, receiving circuit, etc. may be used interchangeably.

Optionally, the communication device 8100 further includes one or more interface circuits 8104. The interface circuit 8104 is connected to the memory 8102. The interface circuit 8104 may be configured to receive signals from the memory 8102 or other devices, and may be configured to send signals to the memory 8102 or other devices. For example, the interface circuit 8104 may read instructions stored in the memory 8102 and send the instructions to the processor 8101.

The communication device 8100 in the above embodiments may be a network device or a terminal, but a scope of the communication device 8100 in the present disclosure is not limited to this, and a structure of the communication device 8100 may not be limited by FIG. 8a. The communication device may be an independent device or part of a larger device. For example, the communication device may be: 1) an independent IC, or a chip, or a chip system or a subsystem; 2) a collection including one or more IC, optionally, the IC collection may also include storage components for storing data and computer programs; 3) an ASIC, such as a modem; 4) modules embedded in other devices; 5) a receiver, a terminal, an intelligent terminal, a cellular phone, a wireless device, a handheld phone, a mobile unit, a vehicle-mounted device, a network device, a cloud device, an artificial intelligence device, etc. ; 6) others.

FIG. 8b is a block diagram of a chip 8200 according to an embodiment of the present disclosure. For a case where the communication device 8100 may be a chip or a chip system, reference may be made to the block diagram of the chip 8200 shown in FIG. 8b, which it is not limited to this.

The chip 8200 includes one or more processors 8201. The processor 8201 is configured to invoke the instructions to cause the chip 8200 to execute any one of the above methods.

In some embodiments, the chip 8200 further includes one or more interface circuits 8202. The interface circuit 8202 is connected to a memory 8203. The interface circuit 8202 may be configured to receive signals from the memory 8203 or other devices, and may be configured to send signals to the memory 8203 or other devices. For example, the interface circuit 8202 may read the instructions stored in the memory 8203 and send the instructions to the processor 8201. Optionally, terms such as interface circuit, interface, transceiver pin, transceiver, etc. may be used interchangeably.

In some embodiments, the chip 8200 further includes one or more memories 8203 for storing instructions. Optionally, all or some of the memories 8203 may be located outside the chip 8200.

The present disclosure also provides a storage medium for storing instructions. When the instructions are running on the communication device 8100, the communication device 8100 is caused to implement any one of the above methods. Optionally, the above storage medium is an electronic storage medium. Optionally, the above storage medium is a computer-readable storage medium, which is not limited to this, and the above storage medium may also be a storage medium readable by other devices. Optionally, the above storage medium may be a non-transitory storage medium, which is not limited to this, and the above storage medium may also be a transitory storage medium.

The present disclosure also provides a program product. When the program product is executed by the communication device 8100, the communication device 8100 is caused to implement any one of the above methods. Optionally, the above program product is a computer program product.

The present disclosure also provides a computer program. When the computer program is running on a computer, the computer is caused to implement any one of the above methods.

1. A communication method, performed by a terminal, comprising:
sending first information, wherein the first information indicates at least one of: a configuration applied by the terminal or a change occurring in the configuration applied by the terminal.

2. The method of claim 1, wherein sending the first information comprises at least one of:
sending the first information in a case that the configuration applied by the terminal changes; or
sending the first information in a case that the terminal has not sent the first information.

3. The method of claim 2, wherein sending the first information in a case that the terminal has not sent the first information comprises:
sending the first information in a case that the terminal has not sent the first information since the terminal is configured to send the first information via a first message.

4. The method of claim 1, further comprising:
receiving second information, wherein the second information is used to configure whether the terminal indicates, via the first information, at least one of: the configuration applied by the terminal or the change occurring in the configuration applied by the terminal.

5. The method of claim 1, wherein the first information is comprised in a first message;
wherein the first message is a measurement report or the first message is user equipment (UE) assistance information (UAI).

6. (canceled)

7. The method of claim 1, further comprising at least one of:
determining whether the configuration applied by the terminal changes, and determining whether a first message that is sent comprises the first information; or
determining whether the configuration applied by the terminal changes, and determining a value of the first information comprised in a first message that is sent.

8. The method of claim 7, wherein
determining whether the configuration applied by the terminal changes, and determining whether the first message that is sent comprises the first information comprises:
determining that the configuration applied by the terminal changes and the first message comprises the first information;
or
determining that the configuration applied by the terminal does not change and the first message comprises the first information; or
determining whether the configuration applied by the terminal changes, and determining the value of the first information comprised in the first message that is sent comprises at least one of: determining that the configuration applied by the terminal changes and the first information is a first value; or determining that the configuration applied by the terminal does not change and the first information is a second value; or
determining whether the configuration applied by the terminal changes comprises at least one of: determining whether the configuration applied by the terminal changes based on whether a height of the terminal changes; or determining whether the configuration applied by the terminal changes from a first configuration to a second configuration.

9. (canceled)

10. The method of claim 1, wherein the first information comprises at least one of:
the first information being set to a parameter name corresponding to a configuration currently applied by the terminal;
the first information being set to a parameter value corresponding to a configuration currently applied by the terminal; or
the first information being set to a configuration identifier corresponding to a configuration currently applied by the terminal.

11. The method of claim 1, wherein the configuration applied by the terminal is at least one of:
a configuration corresponding to a neighboring cell or a non-serving cell; or
a measurement configuration.

12. The method of claim 11, wherein in case of the configuration applied by the terminal is the configuration corresponding to the neighboring cell or the non-serving cell;
the first information further indicates a corresponding relationship between the configuration corresponding to the neighboring cell or the non-serving cell and a cell identifier of the neighboring cell or the non-serving cell;
or,
the first information further indicates at least one of: a corresponding relationship between a default configuration and a cell identifier of the neighboring cell or the non-serving cell, or a corresponding relationship between a non-default configuration and the neighboring cell or the non-serving cell.

13. (canceled)

14. The method of claim 8, wherein the height comprises at least one of:
the height of the terminal being above a first threshold;
the height of the terminal not being above the first threshold;
the height of the terminal being below the first threshold;
the height of the terminal not being below the first threshold;
the height of the terminal falling within a first range; or
the height of the terminal not falling within the first range.

15. (canceled)

16. A communication method, performed by a network device, comprising:
receiving first information, wherein the first information indicates at least one of: a configuration applied by a terminal or a change occurring in the configuration applied by the terminal.

17. The method of claim 16, wherein
the first information is sent in a case that the configuration applied by the terminal changes; or
the first information is sent in a case that the terminal has not sent the first information.

18. The method of claim 17, wherein the first information is sent in a case that the terminal has not sent the first information since the terminal is configured to send the first information via a first message.

19. The method of claim 16, further comprising:
sending second information, wherein the second information is used to configure whether the terminal indicates, via the first information, at least one of: the configuration applied by the terminal or the change occurring in the configuration applied by the terminal.

20-21. (canceled)

22. The method of claim 16, further comprising at least one of:
determining whether the configuration applied by the terminal changes based on whether a received first message comprises the first information; or
determining whether the configuration applied by the terminal changes based on a value of the first information comprised in a received first message.

23. The method of claim 22, wherein
determining whether the configuration applied by the terminal changes based on whether the received first message comprises the first information comprises:
determining that the configuration applied by the terminal changes based on the first message comprising the first information;
or
determining that the configuration applied by the terminal does not change based on the first message comprising the first information; or
determining whether the configuration applied by the terminal changes based on the value of the first information comprised in the received first message comprises at least one of: determining that the configuration applied by the terminal changes based on the first information being a first value; or determining that the configuration applied by the terminal does not change based on the first information being a second value.

24-27. (canceled)

28. The method of claim 22, wherein determining whether the configuration applied by the terminal changes comprises:
determining whether the configuration applied by the terminal changes from a first configuration to a second configuration.

29-33. (canceled)

34. A communication device, comprising:
one or more processors,
wherein the one or more processors are configured to:
send first information, wherein the first information indicates at least one of: a configuration applied by the communication device or a change occurring in the configuration applied by the terminal.

35-36. (canceled)

37. A communication device, comprising:
one or more processors,
wherein the one or more processors are configured to perform the method of claim 16.
